(19) United States
(12) Patent Application Publication
(10) Pub. No.: US 2026/0330215 A1
(43) Pub. Date: Oct. 22, 2026

(54) EFFECTIVE DATA AUGMENTATION TO IMPROVE NL2SQL MODELS WITH LARGE LANGUAGE MODELS

(71) Applicant: Oracle International Corporation, Redwood Shores, CA (US)

(72) Inventors: Gioacchino Tangari, Sydney (AU); Duy Vu, Melbourne (AU); Steve Wai-Chun Siu, Melbourne (AU); Dalu Guo, Sydney (AU); Budhaditya Saha, Sydney (AU); Dai Quoc Nguyen, Raceview (AU); Varsha Kuppur Rajendra, Bellevue, WA (US); Nagesh Panyam Chandrasekarasastry, Melbourne (AU); Cong Duy Vu Hoang, Wantima South (AU); Yakupitiyage Don Thanuja Samodhye Dharmasiri, Melbourne (AU); Thanh Long Duong, Melbourne (AU)

(73) Assignee: Oracle International Corporation, Redwood Shores, CA (US)

(21) Appl. No.: 19/181,689

(22) Filed: Apr. 17, 2025

(51) Int. Cl. G06N 3/08; G06F 16/21; G06F 16/245

(52) U.S. Cl. CPC G06N 3/08; G06F 16/212; G06F 16/245

(57) ABSTRACT

Techniques are disclosed herein for generating a synthetic fine-tuning dataset to train a machine learning model for converting natural language to logical form. In one aspect, a method is disclosed that includes: accessing domain data comprising a set of domain identifiers and generating a set of synthetic training examples by generating a synthetic database schema based on the domain data, synthetic database content based on the synthetic database schema, a synthetic natural language utterance, and a synthetic logical form. A machine learning model may be fine-tuned with the set of synthetic training examples. A subset rehearsal training examples from a rehearsal dataset may be identified using execution-based validation and used to fine-tune the machine learning model.

### FIELD

The present disclosure relates generally to converting natural language to a logical form, and more particularly, to generating a synthetic fine-tuning dataset for training a natural language to logical form model, enabling SQL generation across various domains.

### BACKGROUND

The advent of database management systems has revolutionized the way large datasets are stored, managed, and queried. Traditional databases, such as relational databases, have become the backbone of many applications across various industries. These databases are structured to store data in tables, allowing for the organization and retrieval of information in a systematic manner. The efficiency and reliability of databases have made them indispensable in fields such as finance, healthcare, and e-commerce, where large volumes of data need to be managed with precision and speed.

Structured Query Language (SQL) has been the primary tool for interacting with relational databases. SQL allows users to perform a wide range of operations, including data insertion, updates, deletions, and complex queries to retrieve specific information. The power and flexibility of SQL have made it the standard language for database management. However, the effective use of SQL requires a certain level of expertise, as constructing accurate and efficient queries can be complex and challenging for users who are not well-versed in the language.

In recent years, there has been a significant development in the field of databases with the emergence of text-to-SQL systems. These systems are designed to bridge the gap between natural language and SQL, enabling users to interact with databases using plain, conversational language. Text-to-SQL systems leverage advanced natural language processing (NLP) techniques and machine learning algorithms to translate user queries expressed in natural language into SQL commands. This innovation has the potential to democratize access to databases, allowing users without specialized SQL knowledge to efficiently retrieve and manipulate data.

The integration of text-to-SQL systems into database management represents a significant advancement in making databases more accessible and user-friendly. By simplifying the interaction with databases, these systems can enhance productivity and reduce the learning curve associated with database management. As businesses and organizations continue to accumulate and rely on large datasets, the ability to easily and accurately query databases using natural language will become increasingly valuable. This disclosure presents techniques related to data synthesis techniques related to generating a fine-tuning dataset for training a natural language to SQL model and improvement of text-to-query language technologies.

### BRIEF SUMMARY

Machine learning techniques are disclosed herein (e.g., a computer implemented method, a system, non-transitory computer-readable medium storing code or instructions executable by one or more processors) for generating a synthetic fine-tuning dataset for training a natural language to logical form model, enabling SQL generation across various domains.

In some embodiments, a computer-implemented method includes accessing domain data comprising a set of domain identifiers; generating a set of synthetic training examples, wherein generating the set of synthetic training examples comprises performing an iterative process, and wherein the iterative process comprises: generating, by a first generative model, a synthetic database schema based on the domain data, wherein the synthetic database schema comprises one or more tables, generating, by a second generative model, synthetic database content associated with the synthetic database schema, generating, by a third generative model, a synthetic natural language utterance and a synthetic logical form based on the synthetic database schema and the synthetic database content, and generating a synthetic training example of the set of synthetic training examples to include the synthetic database schema, the synthetic natural language utterance, and the synthetic logical form; and fine-tuning a machine learning model with the set of synthetic training examples to generate a fine-tuned machine learning model.

In some embodiments, the computer-implemented method further includes accessing a rehearsal dataset comprising rehearsal training examples; and generating a fine-tuning dataset comprising the set of synthetic fine-tuning training examples and a subset of the rehearsal training examples, wherein the machine learning model is fine-tuned using the fine-tuning dataset.

In some embodiments, each rehearsal training example of the rehearsal training examples includes a training prompt and a gold logical form, and wherein the subset of the rehearsal training examples is determined by, for each rehearsal training example: generating, by a fourth generative model, a synthetic rehearsal logical form based on the training prompt; executing the synthetic rehearsal logical form and the gold logical form on a database, wherein executing the synthetic rehearsal logical form generates a synthetic rehearsal query result and wherein executing the gold logical form generates a rehearsal query result; determining whether the synthetic rehearsal query result corresponds with the rehearsal query result; and in accordance with determining that the synthetic rehearsal query result corresponds with the rehearsal query result, adding the rehearsal training example to the subset of the rehearsal training examples.

In some embodiments, generating the synthetic database schema comprises: selecting a domain identifier from the set of domain identifiers; identifying one or more keywords associated with the domain identifier, wherein the domain data includes the one or more keywords; generating a business process description based on the domain identifier and the one or more keywords; generating a database schema generation prompt comprising the domain identifier, the one or more keywords, and the business process description; and providing the database schema generation prompt to the first generative model.

In some embodiments, generating the synthetic database content comprises: identifying one or more table relationships based on the synthetic database schema; determining an order of the one or more tables based on the one or more table relationships; and generating table content for each table of the one or more tables based on the order, the one or more table relationships, and the synthetic database schema, wherein the table content is (i) random, (ii) extracted from a prior table, or (iii) any combination thereof.

In some embodiments, generating the synthetic natural language utterance and the synthetic logical form comprises: generating, by the third generative model, the synthetic logical form based on the synthetic database schema comprising the one or more tables or only a subset of the one or more tables, and a gold logical form pattern; generating, by the third generative model, the synthetic natural language utterance based on the synthetic logical form; generating, by the third generative model, a back-translated logical form based on the synthetic natural language utterance; executing the synthetic logical form and the back-translated logical form on a test database including the synthetic database content, wherein executing the synthetic logical form generates a synthetic query result and wherein executing the back-translated logical form generates a back-translated query result; determining whether the synthetic query result corresponds with the back-translated query result; and in accordance with determining that the synthetic query result does not correspond with the back-translated query result, discarding the synthetic logical form and the synthetic natural language utterance.

In some embodiments, generating the synthetic natural language utterance and the synthetic logical form comprises: generating a joint generation prompt comprising a target logical form pattern, a first logical form example, and a second logical form example; and providing the joint generation prompt to the third or a fourth generative model to generate the synthetic natural language utterance and the synthetic logical form.

In some embodiments, the computer-implemented method further includes generating, by a fifth generative model, a schema description based on: (i) a domain description, (ii) a domain keyword, (iii) the synthetic database schema, (iv) a set of target columns, or (v) any combination thereof; and generating, by the fifth generative model, a business logic rule based on the synthetic database schema, wherein the schema description and the business logic rule are included in one or more prompts, and wherein the one or more prompts are provided to the third generative model to generate the synthetic natural language utterance and the synthetic logical form.

In some embodiments, the synthetic natural language utterance and the synthetic logical form are generated based on a real database schema and real database content.

In some embodiments, the computer-implemented method further includes receiving an input from a user, the input comprising a natural language component; providing, to the fine-tuned machine learning model, a prompt comprising an instruction, a database schema associated with the natural language component, and an utterance associated with the natural language component; receiving, from the fine-tuned machine learning model, a logical form corresponding to the utterance based at least in part on the prompt; executing the logical form on a database to obtain a query result; and providing the query result to the user.

In some embodiments, the first generative model, the second generative model, the third generative model, the fourth generative model, and the fifth generative model are all the same model, are all different models, or some are the same model, and some are different models.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a simplified diagram for an example NL2SQL tool, according to various embodiments.

FIG. 2 depicts a simplified diagram for an example generative AI SQL agent system, according to various embodiments.

FIG. 3 depicts a simplified diagram for an example generative AI SQL agent, according to various embodiments.

FIG. 4 depicts a simplified block diagram for training, testing, and producing an NL2SQL Model, according to various embodiments.

FIG. 5 depicts a simplified block diagram for a synthetic data generation system for generating synthetic NL2SQL training examples, according to various embodiments.

FIG. 6 depicts a simplified block diagram for a synthetic schema generation subsystem for generating synthetic database schemas for a synthetic data generation system, according to various embodiments.

FIG. 7 depicts a simplified block diagram for an NL and SQL generation subsystem for generating synthetic NL utterances and SQL queries for a synthetic data generation system, according to various embodiments.

FIG. 8 depicts a simplified block diagram for a rehearsal curation system for generating a curated rehearsal training dataset for fine-tuning an NL2SQL model with rehearsal training examples, according to various embodiments.

FIG. 9 depicts a simplified block diagram for a rehearsal and synthetic fine-tuning data generation system for training an NL2SQL model, according to various embodiments.

FIG. 10 is a flowchart illustrating a process for generating a fine-tuning dataset including augmented training examples to train a machine learning model for transforming natural language to logical form, according to various embodiments.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

In recent years, the amount of data powering different industries and their systems has been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of its business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with the analytics tables via natural language (NL) queries that abstract away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called natural language interfaces for databases (NLIDB). This natural search capability has become more popular over recent years as companies are developing deep-learning approaches for natural language to logical form (NL2LF) such as natural language to SQL (NL2SQL).

Logical form can refer to (i) programming query languages, (ii) intermediate forms, and/or (iii) programming languages. Programming query languages can include database query languages, and examples of programming query languages include, but are not limited to, SQL, PQL, GraphQL, SPARQL, and the like. Intermediate forms can refer to machine-oriented languages and/or meaning representation languages (MRLs) such as OMRL, AMRL, and the like. Examples of programming languages include, but are not limited to, Python, C++, Java, Ruby, and the like. NL2SQL seeks to transform natural language questions to SQL, allowing individuals to run unstructured queries against databases. The converted SQL could also enable digital assistants such as chatbots and others to improve their responses when the answer can be found in different databases or tables with different schemas.

In some instances, NL2SQL transforms natural language to SQL using generative artificial intelligence models such as large language models (LLMs). An LLM is a type of artificial intelligence (AI) that is trained to understand, generate, and manipulate human language (e.g., text data) in a coherent and contextually relevant manner. LLMs have resulted in significant progress in natural language processing tasks such as text-to-code (e.g., text-to-SQL), text generation and translation, and sentiment analysis. Due to their attention mechanisms and deep neural architectures, LLMs excel at capturing nuanced language patterns and correlations in massive volumes of text data. LLMs are designed to predict the next word or token in a sequence of text by computing a probability distribution over a fixed vocabulary for the next token based on the context of the preceding tokens. The prediction is achieved through a series of self-attention mechanisms incorporated in the LLMs that assign varying degrees of importance to different parts of the input sequence that enable the LLMs to make informed predictions. LLMs generate contextually appropriate and coherent text by learning a fixed vocabulary from enormous text corpora and predicting which token included in the fixed vocabulary should be the next token in an output sequence.

While pre-trained LLMs may excel at text-to-code generation, pre-trained LLMs may be unable to capture nuances or differences related to specific tasks or domains. The type of data and training examples used to train an LLM can impact LLM performance and accuracy. As an example, various relational database management systems may have varying implementations of SQL, which may be referred to as SQL dialects. Examples of SQL dialects include but are not limited to SQLite, MySQL, Oracle SQL, SQL Server, PostreSQL, etc. While the basic SQL structure may be the same across SQL dialects, each SQL dialect may have slight variations in syntax, style, and conventions. A predominance of one SQL dialect in training data used to train an NL2SQL model may cause the model to generate SQL queries that follow the rules of the predominant SQL dialect rather than the rules of another desired dialect. For example, many publicly available text-to-SQL benchmarks use SQLite, which can enable pre-trained LLMs to perform well on SQL generation for SQLite but perform poorly on other SQL dialects.

Further, generalized training of pre-trained LLMs may not capture specific uses cases and target domains a user of an NL2SQL service may interact with. As examples, pre-trained LLMs may have low accuracy handling complex analytics questions, generating queries related to business logic, or handling specialized domains. For example, a pre-trained LLM may not understand that “unpaid installments” in an invoice database for a company should be related to specific filtering conditions in clauses within SQL statements generated for the user case. A pre-trained LLM may be fine-tuned with new training examples focused on a new domain, task, SQL dialect, business logic, etc. Generating such datasets using manual data annotation, however, can be challenging due to the amount of time and human resources associated with manual data annotation. In such cases, a synthetic dataset can be generated to reduce time and resource costs. However, validating the correctness of a synthetic dataset can be difficult when test databases populated with data associated with a database schema are not available and generated queries cannot be executed against a database to verify any issues unrelated syntax.

Moreover, fine-tuning a pretrained LLM with a dataset focused on a new task or domain (a domain being a logical grouping of data, referring to interrelated data pertaining to a common purpose, knowledge, object, or concept such as a new task) can result in catastrophic forgetting. In such cases, the fine-tuned LLM may achieve lower accuracy or performance on certain capabilities compared to the pre-trained LLM. As an example, a pre-trained LLM may perform well on a first domain but perform poorly on a second domain. Fine-tuning the pretrained LLM with a dataset including examples related to the second domain may result in the LLM performing well on the second domain but performing worse on the first domain. This can present challenges for NL2SQL services, as users of the model may have specific task or domain needs but still expect basic and general capabilities of the NL2SQL model to be met. To prevent instances of catastrophic forgetting, rehearsal training data can be included to the fine-tuning process. Rehearsal training can include including training examples on tasks the model has already been trained on to reinforce model performance and behavior. However, for many LLMs, rehearsal training data may not be available or accessible. Further, rehearsal training data may include examples with errors that should be corrected before fine-tuning the model with a dataset focused on a new task or domain and the rehearsal examples.

To overcome these challenges and others, a technical solution involving data augmentation techniques for creating a synthetic fine-tuning dataset has been developed. The synthetic fine-tuning dataset can be used to train (e.g., fine-tune) a NL2SQL model and improve performance and accuracy of the NL2SQL model. Synthetic fine-tuning datasets are generated using generative artificial intelligence (AI) models (also described herein simply as generative models, e.g., LLMs) to create comprehensive training examples that include database schemas, schema descriptions, database contents, business logic, natural language utterances, and SQL queries. A database schema can be generated based on a domain identifier and keywords associated with the domain identifier. A generated database schema can be used to generate database contents (e.g., table values, row values, column values, etc.) to enable execution-based verification and filtering for synthetic SQL queries. This ensures that the generated queries are not only syntactically correct but also contextually valid. Additionally, synthetic natural language utterances and SQL queries can be generated based on a synthetic database schema and database contents. A schema description, business logic, or a combination thereof can be generated based on the synthetic database schema and used to generate the natural language utterance and/or SQL queries, and/or used in a final synthetic training example. A curated rehearsal dataset can be combined with the fine-tuning dataset to train an NL2SQL model. Execution-based validation can be performed on the rehearsal training examples to determine which examples should be used. In some examples, the rehearsal dataset may be synthetically generated and validated using synthetic database contents.

In one exemplary embodiment, a computer-implemented method is provided for that includes accessing domain data comprising a set of domain identifiers; generating a set of synthetic training examples, where generating the set of synthetic training examples comprises performing an iterative process, and where the iterative process comprises: generating, by a first generative model, a synthetic database schema based on the domain data, where the synthetic database schema comprises one or more tables, generating, by a second generative model, synthetic database content associated with the synthetic database schema, generating, by a third generative model, a synthetic natural language utterance and a synthetic logical form based on the synthetic database schema and the synthetic database content, and generating a synthetic training example of the set of synthetic training examples to include the synthetic database schema, the synthetic natural language utterance, and the synthetic logical form; and fine-tuning a machine learning model with the set of synthetic training examples to generate a fine-tuned machine learning model.

The use of synthetic fine-tuning datasets directly addresses the issue of SQL dialect variations and domain-specific nuances. By tailoring the synthetic database schema generation to specific domain identifiers and keywords, the data augmentation techniques ensure that NL2SQL models are exposed to diverse SQL dialects and specialized use cases. This approach mitigates the dominance of a single dialect in training data, improving the model's versatility across multiple SQL dialects. Furthermore, generating domain-specific database contents and business logic enhances the model's ability to handle specialized queries, such as analytics questions or filtering conditions unique to particular industries or domains.

Further, execution-based validation and the incorporation of curated rehearsal datasets address the issues of catastrophic forgetting and validation challenges. Execution-based validation ensures that synthetic SQL queries are tested against generated database contents, verifying their correctness beyond syntax and enabling reliable filtering of erroneous examples. Combining synthetic datasets with curated rehearsal datasets reinforces general model capabilities while allowing domain-specific fine-tuning, thus preventing catastrophic forgetting. This method ensures that NL2SQL models maintain accuracy across both specialized domains and general tasks, meeting user expectations for robust and versatile performance.

### Overview of Agents and NL2SQL Framework

An agent (also referred to as a skill, chatbot, chatterbot, talkbot, digital assistant, or the like) is a computer program that can perform conversations with end users. The agent can generally respond to natural-language messages (e.g., questions or comments) through a messaging application that uses natural-language messages. Enterprises may use one or more agent systems to communicate with end users through a messaging application. The messaging application, which may be referred to as a channel, may be an end user preferred messaging application that the end user has already installed and familiar with. Thus, the end user does not need to download and install new applications in order to chat with the agent system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

End users may interact with the agent system through a conversational interaction (sometimes referred to as a conversational user interface (UI)), just as interactions between people. In some cases, the interaction may include the end user providing a utterance such as query: “Please retrieve all invoices greater than ten thousand dollars for the last four years for Customer Y”, to the agent, and the agent responding with a natural language response for the query based on translation of the user's natural language query to a SQL query and execution of the SQL query on an appropriate database.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or other method of conveying a message. In some embodiments, the agent system may convert the content into a standardized logical form (e.g., a SQL query). The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

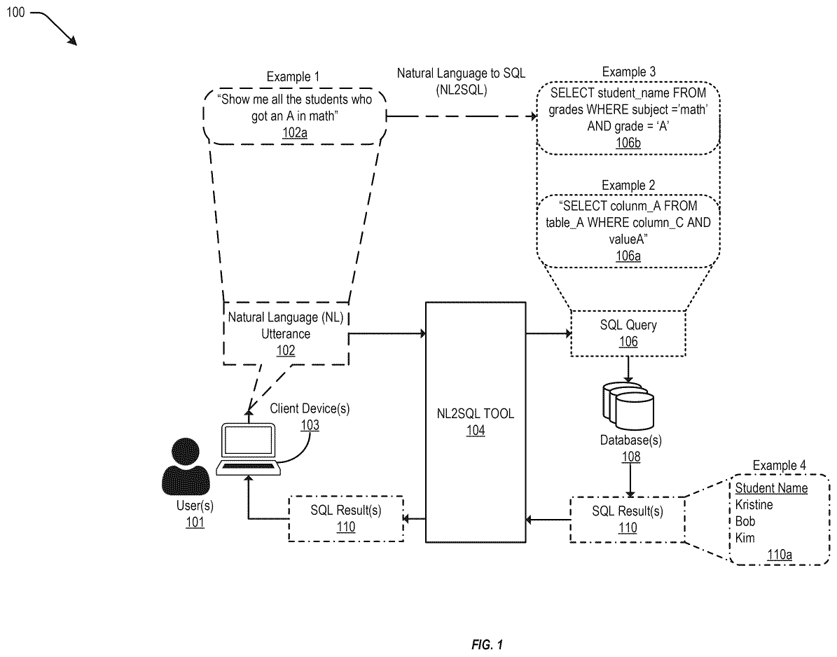

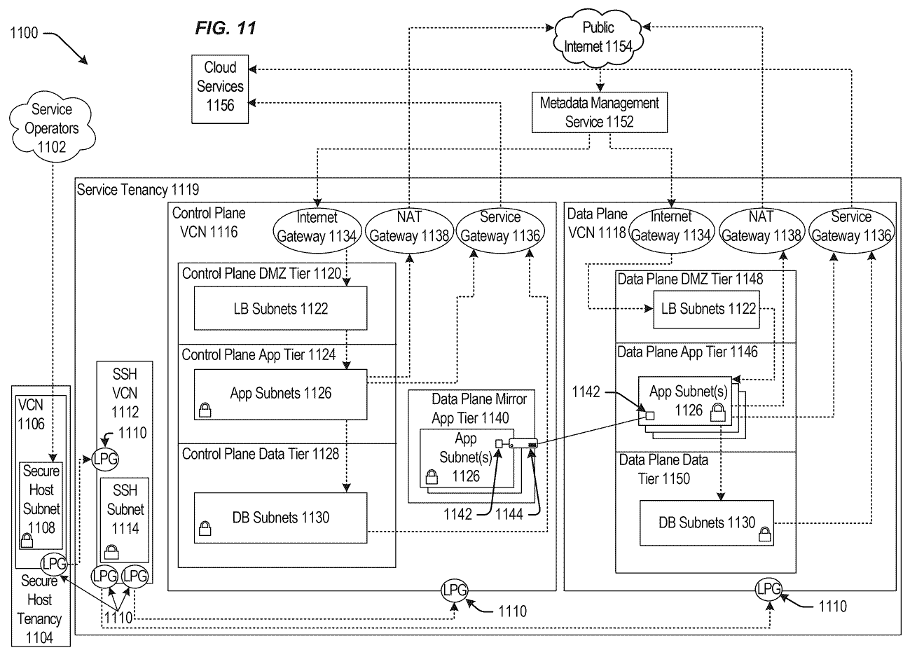

FIG. 1 depicts a simplified diagram of an environment 100 incorporating an exemplary NL2SQL tool, according to various embodiments. Environment 100 includes an NL2SQL tool 104 that enables users 101 to receive (i) a translated version of a natural language utterance 102 (e.g., a natural language query translated into a given programming language such as SQL), and/or (ii) a result of executing an action related to a natural language utterance 102 (e.g., a natural language query translated into a given programming language such as SQL, which is then executed on a database to retrieve a result for query). As shown in FIG. 1, the NL2SQL tool 104 is configured to generate a SQL query 106 and one or more SQL query result(s) 110 based on the provided natural language utterance 102, however other examples may implement tasks in addition to or alternative to SQL query generation (e.g., schema checking, schema linking, sentence completion, extraction of key information, debugging, and other SQL related tasks). The NL2SQL tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 11-15) and the NL2SQL tool can be implemented as part of the IaaS by leveraging the scalable computing resources and storage capabilities provided by the IaaS provider to process and manage large volumes of data and complex computations. This setup can allow the NL2SQL tool 104 to deliver real-time, responsive interactions while ensure high availability, security, and performance scalability to meet varying demand levels. The NL2SQL tool 104 can be embodied or implemented in various physical systems or devices, such as in a computer, a mobile phone, a watch, an appliance, a vehicle, and the like. For the purposes of this example, the NL2SQL tool 104 generates and accepts queries related to SQL, but it should be understood that the techniques described herein are not limited to SQL and the NL2SQL tool 104 can be configured as any other NL2LF tool capable of generating queries and statements using other programming languages (e.g., PRQL, GraphQL, WebAssembly, Python, R, Java, N1QL, and the like).

As illustrated in FIG. 1, a user 101 provides a user input to the NL2SQL tool 104. The user input can be or can include a natural language utterance 102. The natural language utterance can be in text form, such as when the user types a sentence, a question, a text fragment, or phrase and provides it as an input to the NL2SQL tool 104 via client device(s) 103. The client devices(s) 103 can be configured to communicate with the NL2SQL tool 104, provide the natural language utterance 102 to the NL2SQL tool 104 and receive outputs from the NL2SQL tool 104. In some implementations, the natural language utterance 102 can be in speech form, which may be converted to text form and provided to the NL2SQL tool 104. As an example, a natural language utterance 102 such as 102a “Show me all the students who got an A in math” can be spoken by the user 101 and the NL2SQL tool 104 may be configured as a standalone or via a plug-in, or make use of some other audio-to-text translator, configured to translate the audio into text for further processing.

The NL2SQL tool 104 may be or may make use of one or more generative artificial intelligence models such as LLMs configured to generate a SQL query 106 (e.g., 106a or 106b) based on the natural language utterance 102. The NL2SQL tool 104 may receive a prompt including the natural language utterance 102 to generate a SQL query 106 that it is relevant to the user 101 preferences. In some implementations, the user 101 and/or client device 103 generate a prompt including the natural language utterance 102 before providing the prompt to the NL2SQL tool 104. In other implementations, the NL2SQL tool 104 receives the natural language utterance 102 and generates the prompt itself, e.g., populates slots of a prompt template, before providing the prompt to a trained generative artificial intelligence model.

The NL2SQL tool 104 converts the natural language utterance 102 (as in example 1 depicted in FIG. 1) to the SQL query 106. The NL2SQL tool 104 may consider schema information corresponding to one or more databases 108 to generate the SQL query 106. The SQL query 106 (as in examples 2 or 3 depicted in FIG. 1) may be executed on database(s) 108 to obtain a SQL result 110. As a non-limiting example, SQL result 110 can be a list of students who got an A in math based on a generated SQL query 106. The SQL result(s) 110 can be provided back to the user 101 by the NL2SQL tool 104. In some instances, the SQL result(s) 110 are reported back to the user 101 as raw output. In other instances, the SQL result(s) 110 are reported back to the user 101 as part of a natural language response (e.g., a summary) generated by the one or more generative artificial intelligence models in response to the natural language utterance 102. In other instances, the SQL result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the SQL result(s) 110 through the client device(s) 103. Additionally or alternatively, the NL2SQL tool 104 may provide the SQL query 106 to the user(s) via some other means such as an email communication, SMS message, or other type of notification receivable on one or more other computing devices. In some implementations, the SQL query 106 is provided to the user(s) in addition to or without running the SQL query 106 on the database(s) 108 to obtain SQL result(s) 110 (e.g., as part of a feedback request to validate the SQL query 106).

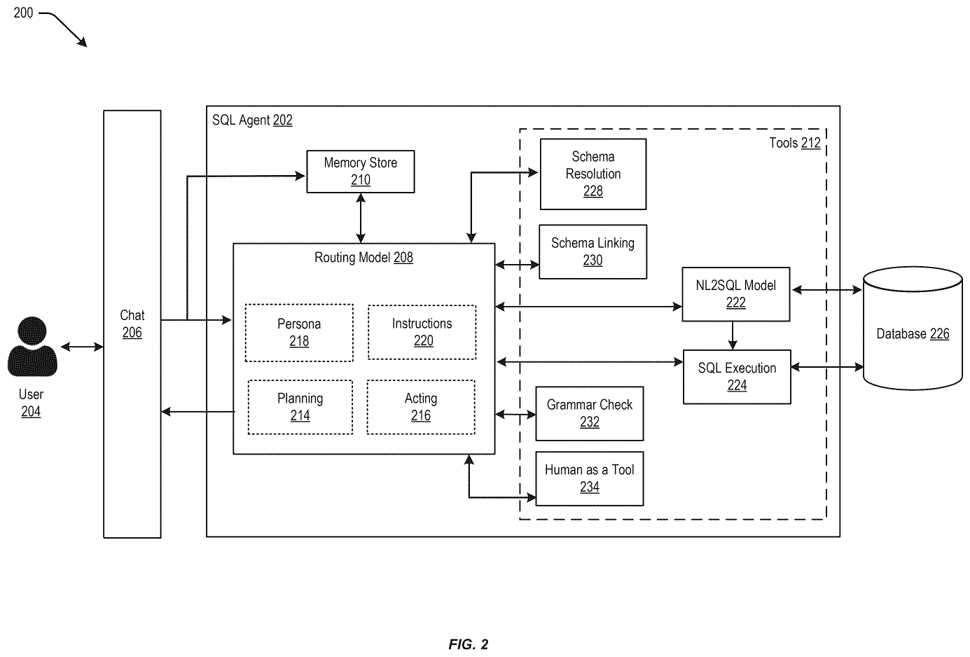

FIG. 2 is a simplified block diagram of a SQL agent system 200 according to certain embodiments. SQL agent system 200 is a computing system that can be implemented in software only, hardware only, firmware only, or any combination of hardware, software, and/or firmware. The SQL agent system 200 can convert natural language questions into SQL to help users complete their data related tasks by leveraging the power of generative artificial intelligence such as LLMs. In addition to their language capabilities (e.g., sentence completion, summarization, extraction of key information from text passages), generative artificial intelligence can generate SQL statements. The purpose of the SQL agent system 200 is to enable users to talk to their databases with the least amount of effort. This may include the SQL agent system 200 interpreting user requests in natural language, reviewing database schema, implementing schema linking (i.e. identify names of tables and columns in natural language questions), generating SQL queries and even executing the SQL statements. In certain embodiments, the SQL agent system 200 can be used to implement one or more tools related to SQL generation, execution, and/or review (e.g., NL2SQL tool 104 as described with respect to FIG. 1). The SQL agent system 200 can include a SQL agent 202 capable of converting a natural language question into a SQL query.

A user 204 can participate in a chat 206 (also described herein as a conversation or an interaction) with the SQL agent 202. The user 204 may interact with the chat 206 via a user interface such as a graphical user interface or conversational user interface. As an example, the user 204 may provide a user input to the SQL agent 202 via a user interface element such as a chat window. The chat 206 can include one or more inputs from the user 204 and one or more responses from the SQL agent 202. The chat 206 may correspond to one or more chat sessions between the user 204 and the SQL agent 202. During the chat 206, the user 204 provides a natural language utterance that can be processed by the SQL agent 202. The natural language utterance can include a question related to a database or SQL generation.

One or more user inputs provided by the user 204 via the chat 206 are provided to the SQL agent 202. Included in the SQL agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the NL2SQL operations such as in-context examples, APIs, external knowledge, and the like. The tools 212 can include functions, APIs, and trained machine learning models that can be used by the SQL agent 202 to interact with external systems (e.g., database 226, external knowledge bases) and/or generate SQL statements.

The routing model 208 may be or may make use of one or more generative artificial intelligence models such as LLMs. The routing model 208 can include a planning 214 component and an acting 216 component (i.e., trained task). Planning 214 includes generating a plan that is comprised of a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the SQL agent 202 may be LLM-based tools configured to receive a prompt and generate a result based at least in part on the prompt. As an example, the tools 212 can include an LLM-based NL2SQL model 222 that generates a SQL statement based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve accuracy of generated responses and customize responses generated by an LLM to the needs of the user 204. In some examples, planning 214 may select a tool from the tools 212 based on the persona 218.

TABLE 1

| Example Persona | Example Description |
|---|---|
| Junior Developer | A user having limited to no experience in writing SQL |
| | queries that requires assistance in writing and optimizing |
| | SQL queries. |
| Expert Developer | A user with several years of experience writing SQL |
| | queries. |
| Business Analyst | A user with strong context about the needs of a company |
| | and wants quick data insights without deep SQL knowledge. |
| Data Scientist | A user focused on extracting and analyzing data efficiently. |

Instructions 220 describe the knowledge bases and tools available to the SQL agent 202. Instructions 220 can be included in a prompt for LLM-based tools and may guide a tool to generate a response relevant to preferences of user 204. Additionally, or alternatively, the prompt can include a table schema, description of columns in the table schema, context, in-context examples, additional instructions, a user question, or any combination thereof. In some examples, context may include contextual information related to the user 204 and/or chat 206 history and may be retrieved from the memory store 210 by the routing model 208. The prompt may further include database schema information corresponding to a database 226.

The routing model 208 may provide the generated prompt to a tool from the tools 212 selected by planning 214. As an example, the NL2SQL model 222 receives a prompt provided by the routing model 208 and generates a SQL query based on the prompt. The NL2SQL model 222 can be trained to convert a natural language question into a SQL query to help the user 204 complete data related tasks. In some examples, the SQL query generated by the NL2SQL model 222 is returned to the user 204 via the chat 206. Additionally, or alternatively, the generated SQL query is provided to a SQL execution 224 tool that is configured to execute SQL queries on the database 226. SQL execution 224 may receive a SQL result from the database 226 and provide the SQL result to the routing model 208. The routing model 208 may provide the SQL result to the user 204 via the chat 206. In some implementations, the routing model 208 may identify an error in the SQL result or determine the SQL query and/or result does not correspond to user 204 needs and generate new plan using planning 214 to correct the error or generate a new SQL query.

Additional examples of tools include, but are not limited to, schema resolution 228, schema linking 230, grammar check 232, and human as a tool 234. Schema resolution 228 may be configured to check for and/or fix any errors within a SQL statement. The SQL agent 202 may use schema resolution 228 after a SQL query is generated by the NL2SQL model 222. Schema linking 230 may be configured to identify proper references to schema values (e.g., tables, columns, condition values) based on schema information and query patterns. Schema linking 230 can include content-based schema linking for mapping values, and name-based schema linking for mapping table and column names for SQL generation. For large schemas, retrieval augmented generation (RAG)-based schema linking may be implemented to retrieve a relevant subset of the schema. Schemas can be stored in a knowledge base (e.g., memory store 210) and relevant schema information can be retrieved based on a natural language query provided by the user 204. In some implementations, the knowledge base includes external data stores and schema linking 230 can include performing a web search to identify relevant schema. The SQL agent 202 may be unable to resolve ambiguities during schema linking 230. In such examples, the SQL agent 202 can ask the user 204 clarifying questions to resolve the ambiguities and/or acquire missing information to resolve the ambiguities.

Also included in the tools 212 is a grammar check 232 that can review grammar of generated statements. Tools 212 can also include human as a tool 234. The SQL agent 202 may seek human input for clarification and disambiguation. Human as a tool 234 may be used to supplement one or more additional tools of the set of tools 212 with human input or intervention. Human as a tool 234 can include asking the user 204 or another user such as a developer for information for correcting previous generations.

The SQL agent 202 may use a singular tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 201 via the chat 206 as received by the routing model 208 (i.e., without additional modifications to the output).

In some implementations, the routing model 208 responds to the user 204 which provided the original query as part of a two-way conversation (e.g., via chat 206). The natural language response may include a natural language component (e.g., answers to questions, information, etc.) and/or a logical form component (e.g., a SQL query). In some embodiments, the routing model 208 may generate a natural language response containing the output generated by the selected tool. The routing model 208 may be configured to generate the natural language response and/or may use a response generation tool to generate the natural language response. The natural language response can be provided to the user 201 via the chat 206. In some implementations, the SQL agent 202 may provide a visualization of the generated output through a plot, table, graph, and the like, via the chat 206. As a particular example, the SQL agent 202 can use the schema linking 230 tool to identify names of table and columns in a natural language utterance (which is an example of NL utterance 102 with respect to FIG. 1) provided by the user 204 and then generate a SQL query using the NL2SQL model 222 based on the identified table and column names. The SQL query may be provided to the user 201 via the chat 206 as generated by the NL2SQL model 222. In some implementations, the routing model 208 may generate a natural language response containing the SQL query and provide the natural language response to the user 201 via the chat 206.

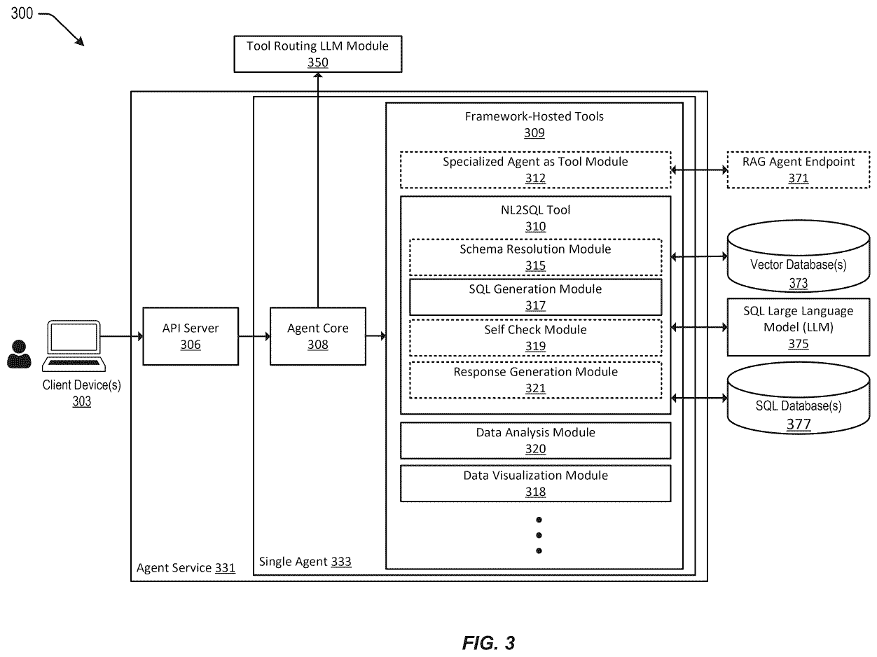

FIG. 3 depicts a simplified diagram 300 for an example generative AI SQL agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to enable communication as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) SQL resolution, generation, and/or execution. By way of a non-limiting example, in analytical use cases using unique software packages (e.g., Oracle™ Analytics Cloud (OAC), Tableau™, etc.), a single analytical dashboard may generate multiple SQL queries using output from previous inputs (e.g., by way of Churn analysis, Funnel analysis, cohort analysis, etc.). The agent core 308 may access a tool routing LLM module 350 in order to identify, select, utilize, and/or train one or more LLM(s) that may suitably apply to the utterance received from the client device(s) 303.

The agent core 308 may include one or more framework-hosted tools 309 for addressing various functions. For example, the framework-hosted tools 309 may include a specialized agent as tool module 312 which may be in communication with a retrieval augmented generation (RAG) endpoint 371. The RAG endpoint 371 may improve an efficacy of one or more LLMs by suitably leveraging various sources of data. For example, retrieving data/documents relevant to the utterance (e.g., question, statement, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the frame-work hosted tools 309 is a NL2SQL tool 310, which is an example of the NL2SQL model 222 with respect to FIG. 2. The NL2SQL tool 310 includes, without limitation, modules 315, 317, 319, and 321. Schema resolution module 315 may function to receive input from the client device(s) 303 requesting the NL2SQL tool 310 check one or more schema for any errors (e.g., syntax errors, sematic errors, etc.) and fix the errors (or recommend a fix). The agent core 308 may provide explanations to the client device(s) 303 about each fix performed. The explanations may be provided in natural language. In some examples, the NL2SQL tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of SQL agent 202 with respect to FIG. 2) may return can include syntax errors and semantic errors. The schema resolution module 315 may reference one or more vector database(s) 373 to obtain and/or store schema.

Also included in the NL2SQL tool 310 is a SQL generation module 317. The SQL generation module 317 may take the utterance received from the client device(s) 303 and construct a SQL query. To do this, the NL2SQL tool 310 may access one or more generative artificial intelligence models such as LLMs (e.g., SQL LLM 375) that may have been trained on generating SQL queries. An LLM may receive the utterance from the NL2SQL tool 310 and may translate the utterance into a relevant SQL query. The SQL generation module 317 may then pass the received SQL query from the LLM to one or more additional modules. For example, the SQL generation module 317 may pass the SQL query returned from the LLM to a response generation module 321. The response generation module 321 may append the SQL query (optionally along with information related to the utterance) and return the SQL query to the client device(s) 303. In addition, or alternatively, the response generation module 321 may pass the SQL query to one or more SQL database(s) 377 to retrieve information related to the utterance. The NL2SQL tool 310 may utilize a self-check module 319, which may function with any one or more of the other modules. The self-check module 319 may automatically try to resolve errors associated with the SQL query and/or LLM prompt containing the utterance. The self-check module 319 may ask clarifying questions to the client device(s) 303 and/or the LLM to resolve the errors.

The framework-hosted tools 309 includes data analysis module 320 and a data visualization module 318. Each of 320 and 318 may function with any of the modules of the framework-hosted tools 309 in order to analyze various analytics and display the various analytics. The analytics may include analysis of schema, SQL queries, LLM accuracy, recommendations, or suitable equivalents.

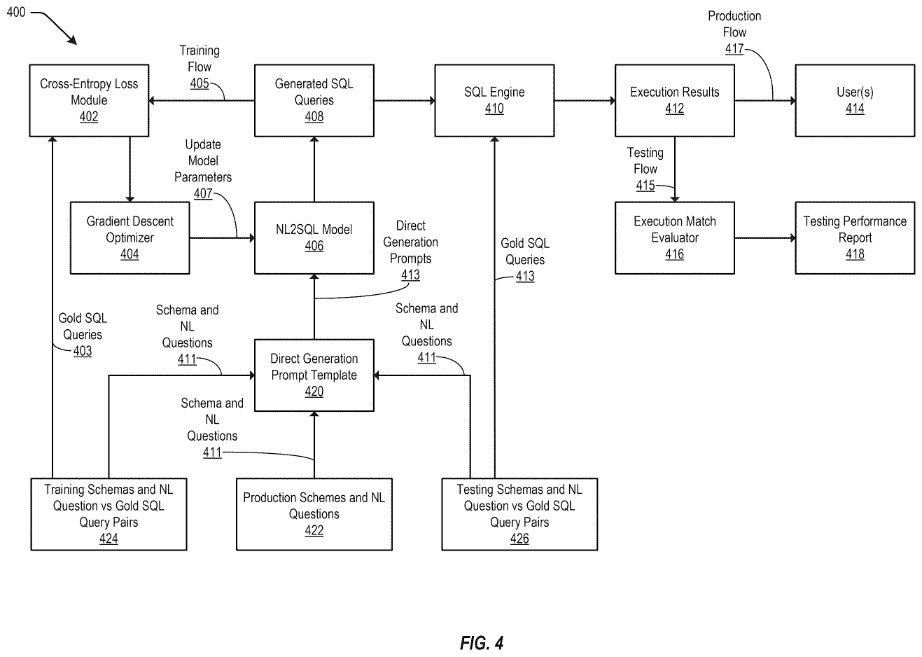

FIG. 4 depicts a simplified block diagram 400 for training, testing, and deployment or production of an NL2SQL Model, according to various embodiments. This simplified overview of training, testing, and inference depicts flows for a NL2SQL direct generation model (however it should be understood that similar steps could be implemented for a generation model that translates to an intermediate database query language which can be used to generate a query in a specific system query language or other for a generation model that translates to another programming language such as PRQL, GraphQL, WebAssembly, Python, R, Java, N1QL, and the like). A NL2SQL model is powered by a machine learning model (e.g., an LLM) configured to convert a NL utterance (e.g., a query posed by a user using an agent) into a logical form, for example, an intermediate database query language such as OMRL or a system query language format, such as SQL or PGQL. If an intermediate database query language format is used then the intermediate database query language can be used to generate a query in a specific system query language (e.g., SQL), which can then be executed for querying a system such as a database to obtain an answer to the user's utterance. If a system query language format is used, then the system query language can be directly executed for querying a system such as a database to obtain an answer to the user's utterance.

One goal of the NL2SQL model is to allow end users to interact with their systems, (e.g., SQL databases) through natural language rather than program specific language queries such as SQL queries. Using a NL2SQL service, users such as business analysts can extract information from their systems without thorough knowledge of a specific programming language and system schemas. The NL2SQL model is an LLM, which is an advanced type of artificial intelligence model designed to understand and generate human language. These models are trained on vast amounts of text data and leverage deep learning techniques to perform a variety of natural language processing tasks, such as text generation, translation, summarization, and answering questions. In the below description, the LLM (NL2SQL model) is designed and trained to convert natural language queries into SQL queries. This involves understanding the semantics of the natural language input, mapping it to the corresponding database schema, and generating a syntactically and semantically correct SQL query that can retrieve the desired information from the database. However, it should be understood that similar techniques could be implemented for other programming languages including other system query languages such as PGQL and/or other intermediate logical forms such as MRL or OMRL.

The input to the Natural Language-to-SQL (NL2SQL) model is a natural language question.

```
For example:
  “Get me the list of employees from Australia.”
The main output from the NL2SQL model is a SQL query.
For example:
  SELECT employee_id, employee_name FROM Employee WHERE country =
  ″Australia″.
Another important input to the NL2SQL model 406 is the database schema that helps the
model to identify relevant tables and columns in the SQL output construction.
For example:
  CREATE TABLE Employee (
    employee_id TEXT(12) NOT NULL,
    employee_name TEXT(100) NOT NULL,
    birth_date DATE NOT NULL,
    hire_date DATE NOT NULL,
    country TEXT(100),
    ...
  )
  CREATE TABLE JobTitle (
    ...
  )
  ...
```

Described herein is a pre-trained NL2SQL model developed based on instruction fine-tuning of LLMs to provide this NL2SQL direct generation capability, e.g., the mapping of (Database Schema, NL Question)→SQL Query. Below is the summary of how the NL2SQL direct generation capability is implemented via instruction fine-tuning.

Data to train a NL2SQL model includes multiple database schemas defined as SQL CREATE TABLE statements:

```
  • Table names
  • Column names and types
  • Primary and foreign keys
  • Other constraints
One Database Schema Example:
  CREATE TABLE aircraft (
    aid NUMERIC(9, 0),
    name TEXT(30),
    distance NUMERIC(6, 0),
    PRIMARY KEY (aid)
  )
  CREATE TABLE employee (
    eid NUMERIC(9, 0),
    name TEXT(30),
    salary NUMERIC(10, 2),
    PRIMARY KEY (eid)
  )
  CREATE TABLE certificate (
    eid NUMERIC(9, 0),
    aid NUMERIC(9, 0),
    PRIMARY KEY (eid, aid),
    FOREIGN KEY(aid) REFERENCES aircraft (aid),
    FOREIGN KEY(eid) REFERENCES employee (eid)
  )
  CREATE TABLE flight (
    flno NUMERIC(4, 0),
    origin TEXT(20),
    destination TEXT(20),
    distance NUMERIC(6, 0),
    departure_date DATE,
    arrival_date DATE,
    price NUMERIC(7, 2),
    aid NUMERIC(9, 0),
    PRIMARY KEY (flno),
    FOREIGN KEY(aid) REFERENCES aircraft (aid)
  )
```

Each database schema can be associated with multiple pairs of natural language questions and corresponding SQL queries.

```
Example of NL Question and corresponding SQL Query:
  NL Question: “What is the name of the employee with salary greater than 100000 and
  with the most certificates to fly planes more than 5000?”
  SQL Query: “SELECT T1.name FROM employee AS T1 JOIN certificate AS T2 ON
  T1.eid = T2.eid JOIN aircraft AS T3 ON T2.aid = T3.aid WHERE T3.distance > 5000
  AND T1.salary > 100000 GROUP BY T1.eid ORDER BY count(*) DESC LIMIT 1”
```

Each question-query pair and its corresponding database schema are populated following a NL2SQL direct generation prompt template to create one direct generation prompt example:

```
Direction NL2SQL Generation Prompt Example:
  Given an input Question, create a syntactically correct Oracle SQL query to run.
  Pay attention to using only the column names that you can see in the schema description.
  Be careful to not query for columns that do not exist. Also, pay attention to which column
  is in which table.
  Please double check the SQL query you generate.
  DO NOT use alias in the SELECT clauses.
  Only use the tables listed below.
  CREATE TABLE aircraft (
    aid NUMERIC(9, 0),
    name TEXT(30),
    distance NUMERIC(6, 0),
    PRIMARY KEY (aid)
  )
  CREATE TABLE employee (
    eid NUMERIC(9, 0),
    name TEXT(30),
    salary NUMERIC(10, 2),
    PRIMARY KEY (eid)
  )
  CREATE TABLE certificate (
    eid NUMERIC(9, 0),
    aid NUMERIC(9, 0),
    PRIMARY KEY (eid, aid),
    FOREIGN KEY(aid) REFERENCES aircraft (aid),
    FOREIGN KEY(eid) REFERENCES employee (eid)
  )
  CREATE TABLE flight (
    flno NUMERIC(4, 0),
    origin TEXT(20),
    destination TEXT(20),
    distance NUMERIC(6, 0),
    departure_date DATE,
    arrival_date DATE,
    price NUMERIC(7, 2),
    aid NUMERIC(9, 0),
    PRIMARY KEY (flno),
    FOREIGN KEY(aid) REFERENCES aircraft (aid)
  )
```

Question: What is the name of the employee with salary greater than 100000 and with the most certificates to fly planes more than 5000?
SQL: “SELECT T1.name FROM employee AS T1 JOIN certificate AS T2 ON T1.eid=
T2.eid JOIN aircraft AS T3 ON T2.aid=T3.aid WHERE T3.distance>5000 AND
T1.salary>100000 GROUP BY T1.eid ORDER BY count (*) DESC LIMIT 1”

The prompt example can then be sent to the LLM model to generate the SQL query during training and testing phases. The gold (ground truth) SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1” is used to evaluate the generated SQL query using a loss function such as cross-entropy loss (e.g., using cross-entropy loss module 402) in training and a performance metric such as execution match in testing. For execution match, both gold and generated SQL queries are executed on the database using the SQL engine. The result sets of the gold and generated SQL queries are compared to check if the results sets are a match.

The training and testing flows start at either a training schemas and NL question versus (vs) gold SQL query pairs block 424 or a testing schemas and NL question versus gold SQL query pairs block 426, respectively, where training and testing data is collected (e.g., acquired or accessed). The data collection can include exploring various data sources such as public datasets, private data collections, or real-time data streams, depending on a project's needs. In some instances, a data source is a public or online repository of information or examples pertinent to a general or target domain space (e.g., NL2SQL task, a target SQL dialect, business area, etc.). Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be a storage device that stores various schemas and natural language questions (including labels for corresponding gold SQL queries 403, 413).

Preprocessing may be performed on the training and testing data (from 424, 426 respectively), serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve. At block 420, the preprocessing includes populating the training and testing data (e.g., schema and NL questions 411) into the direct generation prompt template (as described above) to create direct generation prompts 413 from which the NL2SQL model 406 generates SQL queries.

Once collected, generated, preprocessed, and/or labeled, the data may then be split into the training and testing datasets. The training and testing datasets may comprise the raw data and/or preprocessed data. The training and testing datasets are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

At this stage, hyperparameters may also be acquired or set for the training and testing. The hyperparameters control the overall behavior of the models. Unlike model parameters that are learned automatically during training, hyperparameters are set before training begins and have a significant impact on the performance of the model. For example, in an LLM, hyperparameters include the learning rate, batch size, number of layers, number of attention heads, hidden layer size, dropout rate, weight decay, sequence length, and embedding dimension, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

At block 420, the direct generation prompts (for the training and testing data) are input into the NL2SQL model (at block 406) via a training and testing subsystem for training and/or testing. The training and testing subsystem is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries may be utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models such as the NL2SQL model where the model learns to generate SQL queries (output at block 408) based on the data training data (e.g., training flow 405) provided from the training datasets. During this phase, the model iteratively adjusts its internal model parameters to achieve a preset optimization condition. At blocks 402 and 404, the preset optimization condition can be achieved by minimizing the difference between the model output (e.g., generated SQL queries) and the ground truth labels (e.g., gold SQL queries) in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and testing subsystem, the training subset of data is input into the machine learning algorithms to find a set of model parameters (e.g., weights, coefficients, trees, feature importance, and/or biases) that minimizes or maximizes an objective function (e.g., a loss function, a cost function, a contrastive loss function, a cross-entropy loss function, etc.). To train the machine learning algorithms to achieve accurate predictions, “errors” (e.g., a difference between a predicted label and the ground truth label) need to be minimized. In order to minimize the errors (blocks 402 and 404), the model parameters 407 can be configured to be incrementally updated by minimizing the objective function over the training phase (“optimization”). Various different techniques (e.g., stochastic gradient descent) may be used to perform the optimization. For example, to train machine learning algorithms such as an LLM, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters in a manner as to minimize or maximize an objective function. This cycle is repeated until a desired state (e.g., a predetermined minimum value of the objective function) is reached.

Validating is another phase of training where the model is checked for deficiencies in performance and the hyperparameters are optimized based on validation data provided from the training datasets. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

Once a machine learning model has been trained and validated, it undergoes a final evaluation using the test data provided from the training and testing datasets, which is a separate subset of the data that has not been used during the training or validation phases. This step is important as it provides an unbiased assessment of the model's performance in simulating production operation. The test dataset serves as new, unseen data for the model, mimicking how the model would perform when deployed in actual use. During testing, the model's generated SQL queries (output at block 425) can be compared against the true values (e.g., gold SQL queries) in the test dataset using various performance metrics such as accuracy, precision, recall, and mean squared error, depending on the nature of the problem. Additionally, or alternatively, at blocks 410 and 412, the gold and generated SQL queries are executed on the corresponding database using a SQL engine (execution engine; see below in Production Flow section for detailed description) to obtain execution results. At block 416, the result sets (e.g., testing flow 415) from executing the gold and generated SQL queries are compared using an execution match evaluator to compute accuracy execution match metrics. This process helps to verify the generalizability of the model-its ability to perform well across different data samples and environments-highlighting potential issues like overfitting or underfitting and ensuring that the model is robust and reliable for practical applications. The NL2SQL model is fully validated and tested once the outputs have been reported (e.g., testing performance report) and deemed acceptable by user defined acceptance parameters (block 418). Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

The production flow starts at block 422 where production schemas and natural language utterances (real-world input data) are input into the NL2SQL model via a production subsystem for inference. The production subsystem is comprised of various components for deploying machine learning models such as the NL2SQL model in a production environment. In some instances, the NL2SQL resides as a component of a larger system or service (e.g., use with an agent as described with respect to FIGS. 1-3). In some instances, the NL2SQL model and/or the inferences can be used by downstream applications to provide further information. For example, the inferences can be used to hold a conversation with a user as part of an agent or can be used to provide data analysis to a user via an analytical service such as analytics cloud-based service. Deploying the NL2SQL model includes moving the model(s) from a development environment (e.g., the training and testing subsystem, where it has been trained, validated, and tested), into a production environment where it can make inferences on real-world data (e.g., input data). This step typically starts with the model being saved after training, including its parameters and configuration such as final architecture and hyperparameters. It is then converted, if necessary, into a format that is suitable for deployment, depending on the deployment environment. For instance, a model trained in a developmental computing environment such as Python might be converted into a Java-friendly format for integration into a larger enterprise application. Deployment can be conducted on various platforms, including on-premises servers or cloud environments like OCI, AWS, Azure, Google, etc. (see below discussion of various computer and cloud architectures with respect to FIGS. 11-15).

At block 420, the input data (e.g., production schemas and natural language utterances) are populated into the direct generation prompt template (as described above) to create direct generation prompts from which the NL2SQL model generates SQL queries. At block 406, the direct generation prompt is input into the NL2SQL model via the production subsystem for inference. The NL2SQL model then translates the natural language utterance into a SQL query. This translation process includes the NL2SQL model first parsing the natural language utterance to understand the user's intent. This involves identifying the key components of the request, such as the desired action (e.g., SELECT, UPDATE), the entities involved (e.g., tables, columns), and any conditions or filters. For example, if the user says, “Show me all the customers who signed up in the last month,” the model identifies the action (retrieve data), the entities (customers), and the condition (signed up in the last month). The NL2SQL model then maps the identified entities and conditions to the corresponding elements in the schema (e.g., database schema). This step requires knowledge of the database structure, including table names, column names, and data types (which is included within the direct generation prompt template). Continuing with the example, the model needs to know that “customers” refers to a specific table, and “signed up” corresponds to a column (e.g., ‘signup_date’) in that table. Using the parsed intent and mapped schema elements, the NL2SQL model constructs a syntactically correct SQL query. This involves selecting the appropriate SQL keywords and structuring the query according to SQL syntax rules. For the example request, the LLM would generate the following SQL query:

```
  “sql
  SELECT * FROM customers WHERE signup_date >= DATE_SUB(CURDATE( ),
INTERVAL 1 MONTH);
“
```

The NL2SQL model may then validate the constructed SQL query to ensure it aligns with the user's intent and adheres to the database schema. This could involve checking for syntax errors, ensuring the correct use of SQL functions, and verifying the query against the schema. If necessary, the NL2SQL model refines the query to better match the user's request or correct any identified issues. This step might also involve asking the user for clarification if the original utterance was ambiguous. Once generated and optionally validated, the NL2SQL model outputs the SQL queries at block 425.

At blocks 410 and 412, the SQL queries are executed on the corresponding database using a SQL engine (execution engine) to obtain execution results. The execution engine executes the SQL queries on a database by following a multi-step process that involves parsing, optimizing, and executing the query. Initially, an SQL query is parsed to create an internal representation, typically an Abstract Syntax Tree (AST), which outlines the structure of the query. The engine then consults the database schema to validate the query, ensuring that all referenced tables, columns, and data types exist and are correctly used. Once validated, the query undergoes optimization, where the execution engine determines the most efficient way to access and manipulate the data, often through the use of query optimization techniques such as indexing, join algorithms, and query rewriting. This step aims to minimize resource usage and execution time. Finally, the optimized query is executed against the database. The execution engine processes the query plan, retrieves the required data from the storage engine, and applies any necessary transformations, such as filtering, sorting, or aggregating. The resulting data is then formatted and returned to the user (or user(s)) by way of production flow 417 or application that issued the query (block 414), completing the process of data retrieval.

To manage and maintain its performance, a deployed model such as the NL2SQL model may be continuously monitored to ensure it performs as expected over time. This involves tracking the model's inference accuracy, response times, and other operational metrics. Additionally, the model may require retraining or updates based on new data or changing conditions in the environment it is applied in. This can be useful because machine learning models can drift over time due to changes in the underlying data the models are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Synthetic Training Example Generation

As discussed above, a NL2SQL system is powered by a deep learning model (e.g., an NL2SQL model such as an LLM) configured to convert a natural language (NL) utterance (e.g., a query posed by a user using a digital assistant or chatbot) into a structured query language (SQL) instruction (e.g., a SQL query). Users (e.g., customers) of an NL2SQL service may want the NL2SQL system to generate SQL queries based on requirements and expectations for user use cases and domains. In particular, a user may want to extend NL2SQL query generation capabilities to provide better performance across specialized domains, SQL dialects, complex analytics questions, business logic, and more. To provide specialized query generation, an NL2SQL model can be trained with synthetic fine-tuning data. The synthetic fine-tuning data is generated using a synthetic data generation system that utilizes one or more LLMs to generate various components of a fine-tuning training example (e.g., database schema, database content, natural language utterance, SQL completion, business logic, etc.). The synthetic fine-tuning data is used to fine-tune an NL2SQL model that can be deployed within a NL2SQL system (e.g., the agent-based systems described with respect to FIGS. 1-4) and can generate SQL queries for various tasks and domains with improved accuracy.

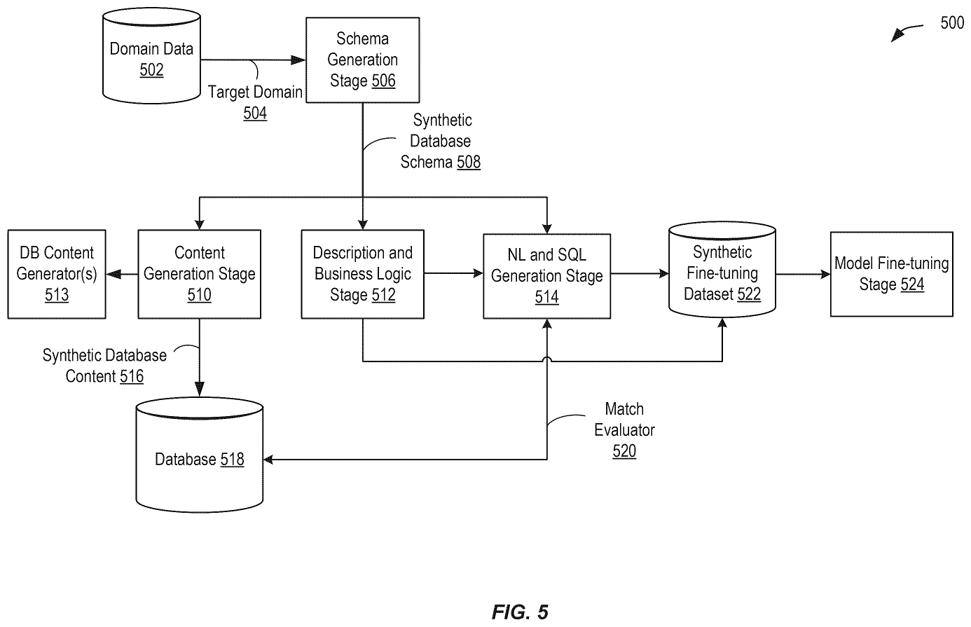

FIG. 5 is simplified block diagram illustrating aspects of a synthetic data generation system 500 for generating synthetic training examples for fine-tuning an NL2SQL model, according to various embodiments. The synthetic data generation system 500 can be implemented using software only, hardware only, firmware only, or any combination of hardware, software, and/or firmware. The data synthesis process of the synthetic data generation system 500 can be used to generate a synthetic fine-tuning dataset and train an NL2SQL model included as part of an NL2SQL agent system or NL2SQL tool (e.g., NL2SQL tool 104 from FIG. 1, NL2SQL model 222 from FIG. 2). As depicted in FIG. 5, the synthetic data generation system 500 can include a schema generation stage 506, content generation stage 510, description and business logic stage 512, NL and SQL generation engine 514, and a model fine-tuning stage 524. Each stage should be understood to be an execution of one or more processes and/or programs implemented with software, hardware, and/or firmware within a system (e.g., as described with respect to FIGS. 11-15). Moreover, it should be understood that the one or more processes and/or programs can be executed as part of an iterative process that ultimately generates a set of synthetic examples. Iteration or an iterative process being the process of repeating a set of instructions or steps multiple times or cycles. For example, a set of instructions or steps may be executed for generating one or more synthetic examples and repeatedly executing the set of instructions or steps multiple times or over multiple cycles results in the generation of multiple synthetic examples (typically different synthetic examples), i.e., the set of synthetic examples. Each cycle of the set of instructions or steps may be executed serially, or multiple cycles of the set of instructions or steps may be executed in parallel.

The synthetic data generation system 500 access domain data 502. The domain data 502 can include a set of domain identifiers (e.g., a set of names or globally unique identifiers (GUID) specified for various domains) for which an NL2SQL model may generate SQL queries, or for which data may be stored in a database. Examples of domain identifiers include, but are not limited to, an NL2SQL task, a target SQL dialect, a business area, etc. Particular examples of business domain identifiers include, but are not limited to, financial transactions, invoice management, supplier accounts, etc. Each domain identifier or the corresponding domain may be associated with a set of keywords. For example, a supplier account and invoice management domain may be associated with keywords including but not limited to organizations, party sites, accounts payable invoices, etc. Domain data 502 may be stored in one or more storage devices or databases and accessed and/or retrieved by the schema generation stage 506. In some examples, domain data 502 can be provided by a user, accessed from a publicly available dataset, and/or generated based on a production use case.

A target domain 504 from the domain data 502 is provided to the schema generation stage 506. The target domain 504 may be selected based on an identified area of underperformance for the NL2SQL model or an area for which training data is insufficient. A set of keywords associated with the target domain 504 can also be provided to the schema generation stage 506. The schema generation stage 506 generates a synthetic database schema 508 based on the target domain 504 and any corresponding keywords. The synthetic database schema 508 describes the structure of a database, including tables, the fields within those tables, the relationships between the tables, and any constraints or rules governing the data. Each table in the database represents a collection of related data. Columns represent the attributes or properties of the data stored in the table. Each column has a name and a data type (e.g., integer, varchar, date). The synthetic database schema 508 represents the structure of a database with a set of executable statements such as CREATE TABLE statements. The schema generation stage 506 utilizes one or more generative models (e.g., LLMs) to generate the synthetic database schema 508 based on the domain data 502. The schema generation stage 506 can construct and populate a prompt including the domain identifiers and keywords and provide the prompt to the one or more generative models to generate the synthetic database schema 508. In some examples, the schema generation stage 506 utilizes the generative models to generate a business process description based on the domain and keywords. The business process description can describe a workflow that includes using an NL2SQL model for SQL generation and/or analytics. In such examples, the schema generation stage 506 may construct a prompt including the domain, keywords, and the business process description to generate the synthetic database schema 508.

The synthetic database schema 508 generated by the schema generation stage 506 is provided to a content generation stage 510. The content generation stage 510 generates synthetic database content 516 for a database 518 based on the synthetic database schema 508. Database content can be structured or unstructured data (e.g., numeric values, string values, text files, etc.) that can be stored in the database 518 and can include, but is not limited to, table values, row values, column values, etc., that can be inserted into the database 518. Populating the database 518 with synthetic database content 516 can enable execution-based validation of synthetic SQL statements generated at a later stage (e.g., by the NL and SQL generation stage 514). For example, a synthetic query can be executed on the database 518 populated with the synthetic database content 516 and the synthetic query may generate a result that may include a table value such as a numeric, string, table, etc. The synthetic database content 516 may be randomly generated by one or more generative models (e.g., DB content generator(s) 513). SQL queries may be executed on the database 518 via a SQL engine (e.g., as described at block 410 and 412 of FIG. 4).

In some examples, the content generation stage 510 can implement an algorithm (e.g., a multi-step sampling algorithm) to generate and populate values into the database 518. The algorithm can be implemented using software, hardware, or a combination thereof. The algorithm can include steps such as creating empty tables, determining an order of tables for data population, and inserting values into the 518. The algorithm can include executing CREATE TABLE statements to create empty tables within the database 518. In some examples, the CREATE TABLE statements are extracted from the synthetic database schema 508 generated by the schema generation stage 506.

Based on the synthetic database schema 508, the content generation stage 510 determines an order of tables included in the synthetic database schema 508. Tables in the database 518 can have various types of relationships (e.g., one-to-one, one-to-many, many-to-many, etc.). A table relationship may be identified based on a table reference reflected in various types of keys (e.g., indexes) included in the synthetic database schema 508. A primary key can represent a column within a table where each row is uniquely identified. A foreign key can represent a column in a table whose values must match the values of a column (e.g., a primary key) in another table. For example, if a table A includes a field called customerID and table B includes a foreign key for the customerID field in table A, table B references table A and the customerID column for table B should match the customerID column in table A.

To maintain such table relationships, synthetic database content 516 is generated in an order such that a table containing a foreign key is populated after the table it references (e.g., table B should be populated after table A). The content generation stage 510 can identify table relationships based on table references to determine a table order. In some examples, a table order may not be generated. However, in such examples, if content for a primary key is generated after content for a foreign key, the content generation stage 510 may reenter the populated data for the foreign key to match the referenced key.

The order of tables can be determined by generating a graphical representation (e.g., a directed acyclic graph) of the synthetic database schema 508. The graph can include a set of nodes connected by edges. In the graph, each node may represent a table in the synthetic database schema 508 and a directed edge may represent a table reference (e.g., a foreign key being present in a table). The content generation stage 510 may generate a list of tables based on a traversal of the graph. The list of tables can be in topological order such that each node of the directed acyclic graph appears in the list before any descendants of the node. As an example, a table represented by a node that is not the source of any directed edges in the graph may be ordered towards the beginning of the list. Using the list of tables, tables that do not include any table references can be populated before tables with references.

Tables that do not contain any foreign keys can be populated with random data generated by one or more generative models (e.g. database (DB) content generator(s) 513). The content generator(s) 513 can generate INSERT INTO statements that can be executed against the database 518 to populate the previously created empty tables. The content generation stage 510 may construct a prompt for generating database content. In some examples, the content generation stage 510 accesses a content generation prompt template and perform a slot-filling process to populate the template with relevant sections of the prompt. An example prompt for a database content generator(s) 513 to generate data for a table without foreign primary keys is below:

<s>[INST] Your task is to generate random data rows for a SQL database table. Please
follow below rules:
- Use an INSERT INTO VALUES statement
- Only use the SQLite format
- Create at least {NUM_ROWS} data rows with explicit VALUES tuples
- Make sure the PRIMARY KEY constrain is maintained
Given the below table schema defined by a SQL CREATE TABLE statement, generate
random data rows for the table:
{CREATE_TABLE};
[/INST]
------------------------------------------------------------------------------------------------------------
{NUM_ROWS} -> 25
{CREATE_TABLE} -> CREATE TABLE Customers (
CustomerID INT PRIMARY KEY,
FirstName TEXT NOT NULL,
LastName TEXT NOT NULL,
Email TEXT NOT NULL,
PhoneNumber TEXT NOT NULL
);

After generating random data for tables without any table references, the content generation stage 510 can populate tables with a reference to a prior table (e.g., via a foreign key). The values of foreign keys are randomly drawn from given lists retrieved from previously generated tables. Values for columns that are not foreign keys may be randomly generated. The content generation stage 510 can construct a separate prompt for generating data for a table with a foreign key. An example foreign key generation prompt for the DB content generator(s) 513 is below:

<s>[INST] Your task is to generate random data rows for a SQL database table. Please
follow below rules:
- Use an INSERT INTO VALUES statement
- Only use the SQLite format
- Create at least {NUM_ROWS} data rows with explicit VALUES tuples
- Make sure the PRIMARY KEY constrain is maintained
All FOREIGN KEY constraints should be maintained by sampling FOREIGN KEY
columns from below value lists:
{VALUE_LIST}
Given the below table schema defined by a SQL CREATE TABLE statement, generate
random data rows for the table:
{CREATE_TABLE}
[/INST]
------------------------------------------------------------------------------------------------------------
{NUM_ROWS}-> 25
(VALUE_LIST}-> - ProductID ~ [ 1, 2, 3, 4, 5, 6, 7, 8, 9, 10, 11, 12, 13, 14, 15, 16, 17,
18, 19, 20, 21, 22, 23, 24, 25 ]
{CREATE_TABLE} -> CREATE TABLE Components (
ComponentID INT PRIMARY KEY,
ProductID INT NOT NULL,
ComponentName TEXT NOT NULL,
Description TEXT NOT NULL,
Price DECIMAL(10,2) NOT NULL,
FOREIGN KEY (ProductID) REFERENCES Products(ProductID)
)

The content generation stage 510 can extract INSERT INTO statements from the outputs of the database content generator(s) execute the statements on the database 518. In some examples, a filtering process may be performed to discard any non-compliant or nonexecutable INSERT INTO statements. In some examples, all extracted INSERT INTO statements are executed against the database 518 and any statements that produce errors are ignored. In such examples, executions that produce an error may not successfully populate the database 518 with any data and may be safely ignored.

The content generation stage 510 can perform data integrity checks to ensure that query execution properly populates the database 518. As an example, for SQLite synthetic training examples, a pragma foreign key check may be executed to identify and remove examples where a foreign key value is not present as the primary key value. The content generation stage 510 may create a database file using the generated CREATE TABLE and INSERT INTO statements. One or more data integrity checks can be performed on the database file, and rows containing an error may be removed. The data integrity checks may be executed on the database file until no additional problems are encountered. If all tables have a target number of data rows after performing the data integrity checks, the final database file may be kept. The contents of the database 518 may correspond to the final database file. Otherwise, the algorithm implemented by the content generation stage 510 may be repeatedly executed with a larger target number of data rows (i.e., increasing the value of NUM_ROWS in the content generation prompts above) to ensure each table contain content and can be executed against.

Additionally or alternatively, the synthetic database schema 508 is provided to a description and business logic stage 512. The description and business logic stage 512 may use one or more generative models (e.g., LLMs) to generate a schema description based on the target domain 504, domain keywords (e.g., from domain data 502) associated with the target domain 504, the synthetic database schema 508, descriptions of any acronyms in the table, and column names. The schema description can include descriptions of various aspects of the synthetic schema including, but not limited to, columns, tables, constraints, table relationships, data types, etc. In some examples, a list of target columns may be provided to the generative models to generate descriptions for each target column. The list of target columns may be included for large schemas where a subset of the tables in the database schema may be target for SQL generation. Including a schema description in a training example used to fine-tune an NL2SQL model may resolve ambiguities in table and column names and may guide a model to use correct tables and columns in SQL queries. The description and business logic stage 512 can construct a prompt and provide the prompt to the generative model(s) to generate the schema description. The description and business logic stage 512 may access a prompt template and populate the prompt template using a slot-filling process. An example prompt for schema generation is below:

“““Your task is to generate a description for some columns of a database schema in a
domain. You are given a domain name, a list of important keywords, a database schema
in the SQL syntax, and description of some important acronyms in column names, then a
list of columns where descriptions need to be generated.
- Only definition of some important acronyms are listed, you should also use your
knowledge in the given domain to figure out full versions of other acronyms.
- Some acronyms also appear with their full versions in some column names, please pay
attention and use these information to infer some acronyms that are not provided
explicitly.
- Create a separate description for each column and put it on a separate line. Note that the
domain is {DOMAIN} with the following main keywords: {KEYWORDS}
Database Table:
{SCHEMA}
Acronym Descriptions:
{ACRONYM_DESCRIPTIONS}
Columns to Generate: {COLUMNS}
Column Descriptions:
”””

| Column Name | Column Type | Column Description |
|---|---|---|
| COMPANY | NVARCHAR (240) | The name of the company or organization |
| | | associated with the data in this table. |
| ENTITY_ID | NUMBER | A unique identifier for each entity or division |
| | | within the company |
| PROJECT_ID | NUMBER(15) | A unique identifier for each project. |
| . . . | . . . | . . . |

Additionally or alternatively, the description and business logic stage 512 can generate business logic using one or more generative model(s) (e.g., LLMs). The generative model(s) may be the same as or different from the generative model(s) used to generate the schema description. Business logic can include rules for SQL queries for handling specific terms and/or deriving columns. As an example, the business logic can include information about columns and how to convert the columns to the proper values based on user preferences and/or how data is stored in a databased managed by a user. The business logic can help a model generate more accurate SQL queries, such as including the correct filtering correct filtering conditions in WHERE clauses or using correct JOIN tables. The business logic can guide the model to use a formula if a SQL query references certain columns. Two samples of business logic are provided below:

```
Sample 1:
1. station
  * ‘is_installed_recently‘ as installation\_date >= date(′now′,′−7 days′)
2. status
  * ‘is_full‘ as docks\_available = dock\_count
  * ‘is_empty‘ as bikes\_available = 0
3. trip
  * ‘trip_duration_mins‘ as duration / 60.0
  * ‘is_recurring_user‘ as subscription\_type = ′Subscriber′
4. weather
  * ‘is_rainy‘ as precipitation\_inches > ′0′
  * ‘is_foggy‘ as cloud\_cover > 75
Sample 2:
1. station table: total\_trips (integer) − number of trips that start from this station. This can
be calculated by counting the number of rows in the trip table
with the same start\_station\_id.
‘‘‘sql
SELECT start_station_id, COUNT(*) as total_trips
FROM trip
GROUP BY start_station_id;
‘‘‘
...
‘‘‘
4. weather table: average\_temperature\_f (integer) − average temperature during the day.
This can be calculated by averaging max\_temperature\_f,
mean\_temperature\_f, and min\_temperature\_f.
‘‘‘sql
SELECT date, (max_temperature_f + mean_temperature_f + min_temperature_f) / 3 as
average_temperature_f
FROM weather;
‘‘‘
```

From the generated business logic, the description and business logic stage 512 may select a target business logic. The target business logic may be a full sample, or a subset of the business logic generated by the generative models. The selected business rules can be appended to sequential SQL and NL generation prompts to create question and SQL pairs that adhere to the selected business rules.

Additionally or alternatively, the synthetic database schema 508 is provided to the NL and SQL generation stage 514. The NL and SQL generation stage 514 generates synthetic natural language and synthetic SQL pair that can be included in a training example. In some implementations, the NL and SQL generation stage 514 implements sequential generation. In such implementations, a generative model is prompted to generate a SQL query based on the synthetic database schema 508, schema description, business logic, target domain 504, domain keywords, or a combination thereof. The generated synthetic SQL query is used to generate a corresponding NL utterance by prompting the same or a different generative model. The synthetic NL question may be used to prompt the generative model to generate a back-translated synthetic SQL query, and the back-translated SQL query may be used to determine the quality of the generated SQL query and NL utterance. The synthetic SQL query and the back-translated SQL query can be executed on the database 518 populated with synthetic database content 516 and a match evaluator 520 can perform a match comparison on the results of the synthetic SQL query and the back-translated SQL query. The match evaluator 520 may be implemented as described at blocks 412 and 416 of FIG. 4. If the results are determined to match, the synthetic SQL query and natural language utterance may be kept and included in training examples for the synthetic fine-tuning dataset 522. In some examples, the match evaluator 520 may determine the results match if the result of executing the synthetic SQL query is substantially the result of executing the back-translated SQL query.

Additionally or alternatively, the NL and SQL generation stage 514 implements joint generation with in-context examples. Joint generation can include using one or more generation AI models to generate an NL and SQL pair using a single prompt. The prompt can include examples of good and bad SQL statements that the model should or should not follow when generating an SQL query. In some examples, joint generation can be performed after sequential generation has generated a number of bad SQL examples that can be included in the joint generation prompt. Examples of bad SQL queries may be examples of synthetic SQL statements that have been discarded after evaluation-based validation (e.g., by the match evaluator 520). In some examples, joint generation is implemented if a set of complete fine-tuning training examples are accessible, but the set does not contain enough training examples with good natural language utterances and SQL queries.

Training examples for a synthetic fine-tuning dataset 522 are generated based on the synthetic components generated by the schema generation stage 506, content generation stage 510, description and business logic stage 512, and NL and SQL generation stage 514. Each training example includes a prompt, which can include the synthetic database schema 508, synthetic NL utterance, business logic, schema description, or combinations thereof. In some implementations, a training example may be generated by associating the prompt with a synthetic SQL query and storing the association in a data store, table and/or matrix. In some implementations, a training example may be generated by labelling a prompt including the synthetic database schema 508, synthetic NL utterance, business logic, and/or schema description as an input and labelling a corresponding synthetic SQL completion as an output to create an input-output pair. The synthetic fine-tuning dataset 522 may be used for training a model as described in the training schemas and NL question versus vs. gold SQL query pairs block 424 from FIG. 4.

The synthetic fine-tuning dataset 522 can be used by a model fine-tuning stage 524 to generate a fine-tuned model (e.g., a fine-tuned machine learning model). The model fine-tuning stage 524 may include a training process described in FIG. 4. A fine-tuned machine learning model refers to a pre-trained model (e.g., a pre-trained machine learning model or generically referred to herein in some instances as a machine learning model) that has been further trained or adapted to perform well on a specific task or domain (e.g., database object name handling capabilities in SQL generation). The process typically involves taking a general-purpose model that has already been trained on a broad dataset and refining it using a smaller, task-specific dataset. Fine-tuning can include adjusting the parameters of a pre-trained model by performing additional training using training examples (e.g., synthetic fine-tuning dataset 522) for a specific task or domain such as SQL generation for specific SQL dialect rules and constraints. The qualities or characteristics that make a model fine-tuned may include: adjusted to address a particular problem, use case, or domain, retains the foundational knowledge learned during its initial pre-training while adapting to the specific task, fine-tuned model demonstrates better accuracy, relevance, or effectiveness in the specific task compared to the original pre-trained model, the model's outputs are tailored to the language, structure, or requirements of the specific domain or task, weights and biases (model parameters) of the model are updated during fine-tuning to optimize performance for the specific task, while avoiding overfitting to the smaller fine-tuning dataset, learn nuances specific to the task or field for which it is fine-tuned, or any combination thereof. The model fine-tuning stage 524 may fine-tune an NL2SQL model which may be deployed in a production environment (e.g., NL2SQL model 222 of FIG. 2).

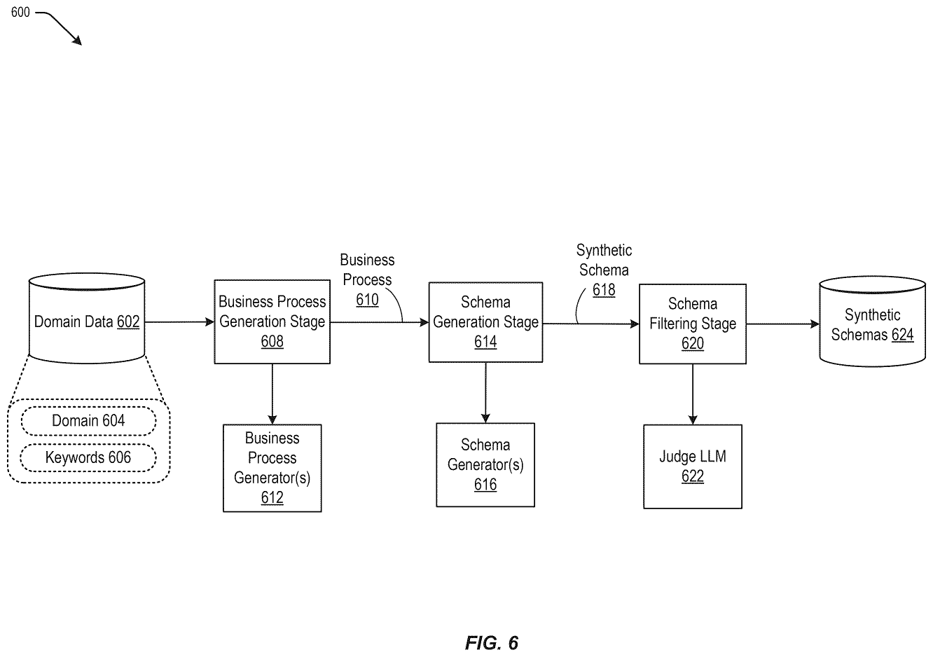

FIG. 6 depicts a simplified block diagram illustrating aspects of a synthetic schema generation subsystem 600, according to various embodiments. The synthetic schema generation subsystem 600 can be a subsystem of the synthetic data generation system 500 and may be used to implement a schema generation stage 506 as described in FIG. 5 using software only, hardware only, firmware only, or any combination of software, hardware, and/or firmware. As depicted in FIG. 6, the synthetic schema generation subsystem 600 can include a business process generation stage 608, schema generation stage 614, and schema filtering stage 620. Each stage should be understood to be an execution of one or more processes and/or programs implemented with software, hardware, and/or firmware within a system (e.g., as described with respect to FIGS. 11-15).

The synthetic schema generation subsystem 600 can access domain data 602 (e.g., domain data 502). The domain data 602 can include a set of domain identifiers and keywords. A domain identifier 604 (for a given domain) may be associated with a set of keywords 606. Each keyword of the set of keywords 606 may be associated with more than one domain identifiers 604. As an example, the domain identifier 604 can be “Financials and Project Management.” The domain identifier 604 may be associated with keywords 606 such as “Comprehensive Spending Review, Accounts Receivables, Unbilled Receivables, Cost, Revenue, Profit, Budget”, etc. The domain identifier 604 and keywords 606 are provided to a business process generation stage 608 to generate a business process 610. The business process 610 may include an example persona (e.g., as described in FIG. 2) and a workflow associated with the example persona. In some examples, the business process 610 can include a description of a workflow that involves querying a database associated with the domain identifier 604. Below is an example of a business process description:

The business process for supplier account and invoice management involves the following steps:
1. A company purchases goods or services from a supplier.
2. The supplier sends an invoice to the company, indicating the amount due for the goods or services provided.
3. The company's accounts payable department reviews the invoice and verifies the accuracy of the charges.
4. The invoice is approved by a manager or authorized employee.
5. The company makes a payment to the supplier, either in full or in installments, according to the payment schedule agreed upon.
6. The payment is recorded in the company's financial system, and the accounts payable balance is updated.
7. The company may generate reports or financial statements to track its spending on suppliers and the status of its accounts payable.
The key stakeholders in this process include the suppliers, who provide the goods or services and issue the invoices; the company's accounts payable team, which manages the payment process; and the company's management, which approves the payments and monitors the company's financial health.
It's important for the company to have a robust system for managing its accounts payable to ensure that payments are made accurately and on time, and to maintain good relationships with its suppliers.

The business process generation stage 608 can use one or more business process generator(s) 612 to generate the business process 610. The business process generator(s) 612 can be one or more generative models (e.g., LLMs). The business process generation stage 608 may construct a prompt including one or more domain identifiers and a set of keywords associated with each domain. In some examples, the business process generations stage 608 accesses a business process generation prompt template and performs a slot-filling process to construct the business process generation prompt. The business process generation prompt can include in-context examples of business processes. The business process generation stage 608 may access a set of example business process. The set of example business processes may be generated based on known user preferences and/or may be provided by a user. The business process generation stage 608 can perform a random sampling of the set of example business process to identify business processes examples to include in the business process generation prompt. In some examples, the business process generations stage 608 can perform a filtering process (e.g., using human-in-the-loop validation) to identify and discard any low-quality business processes generated by the business process generator(s) 612. Below is an example of a business process generation prompt:

Below are 2 examples of business process descriptions for domains given their DOMAIN
and KEYWORDS.
DOMAIN:
Supplier Account and Invoice Management
KEYWORDS:
Organizations, Parties, Party Sites, Accounts Payable Invoices, Accounts Payables
Invoice Instalments
BUSINESS PROCESS:
Imagine you are the accountant of a company. A main part of your job is to pay invoices
(aka money) to your
suppliers. The workflow is as follows:
1. Your company buys a product(s) from a supplier.
2. The supplier sends an invoice to your company. An invoice indicates the amount that
your company needs to pay
the supplier.
3. A manager approves the invoice.
4. You (the accountant) transfer money to the supplier.
...
Please draft a comprehensive description of the following business process given its
DOMAIN and KEYWORDS.
DOMAIN:
{DOMAIN_DESCRIPTION}
KEYWORDS:
{DOMAIN_KEYWORDS}
BUSINESS PROCESS:

The domain identifier 604, keywords 606, and business process 610 are provided to a schema generation stage 614. The schema generation stage 614 can use one or more schema generator(s) 616 to generate a synthetic database schema 618 (e.g., synthetic database schema 508). The schema generator(s) 616 can be one or more generative models (e.g., LLMs) and may be the same as or different from the business process generator(s) 612. The schema generation stage 614 can construct a schema generation prompt including the domain identifier 604, keywords 606, and business process 610. The schema generator(s) 616 may generate a synthetic database schema 618 including one or more CREATE TABLE statements.

In some examples, the synthetic schema generation subsystem 600 can include a schema filtering stage 620. The schema filtering stage 620 can filter synthetic schemas based on filtering criteria. The filtering criteria for keeping or discarding a synthetic database schema 618 can include, but are not limited to, keeping the synthetic database schema 618 if the number of table and columns per table are within a target range and removing the synthetic database schema 618 if it includes an isolated table or a circular foreign key reference. In some examples, CREATE TABLE statements included in the synthetic database schema 618 may be executed on a target database (e.g., database 518), and the synthetic database schema 618 can be discarded if the execution fails. A key reference check may be performed on the synthetic database schema 618 based on a target SQL dialect and/or RDBMS. For example, pragma integrity_check and quick_check may be performed for training examples on synthetic schemas generated for SQLite.

In some implementations, the schema filtering stage 620 applies a clustering approach to reduce the number of synthetic database schemas. As a particular example of a clustering approach, schemas are filtered based on a combination of text embeddings and graph embeddings. A text embedding for each schema can be generated by averaging embeddings of all CREATE TABLE statements generated by a code embedding model (e.g., CodeT5+, UniXcoder, etc.). A graph embedding can be generated for each schema by constructing a directed graph representing tables in the synthetic database schema 618. Tables can be represented by nodes within the directed graph, and foreign keys can be represented by directed edges in the graph. The graph embedding may be generated by a graph embedding model. The text (i.e., naming information) and graph (i.e., structural information) embeddings may be concatenated and a dimension reduction model can be used to project the concatenated embedding vectors into a lower dimension to improve clustering quality. A clustering algorithm (e.g., Agglomerative Clustering) may be applied to the low-dimensional embedding vectors to cluster candidate schemas into groups. Within each group, a candidate schema with the highest rank of table and column counts or central tables may be selected to be included in the synthetic schemas 624. In some examples, a human-in-the-loop validation may be performed on the synthetic schemas 624 after a clustering method is applied to reduce the number of schemas that will undergo manual validation.

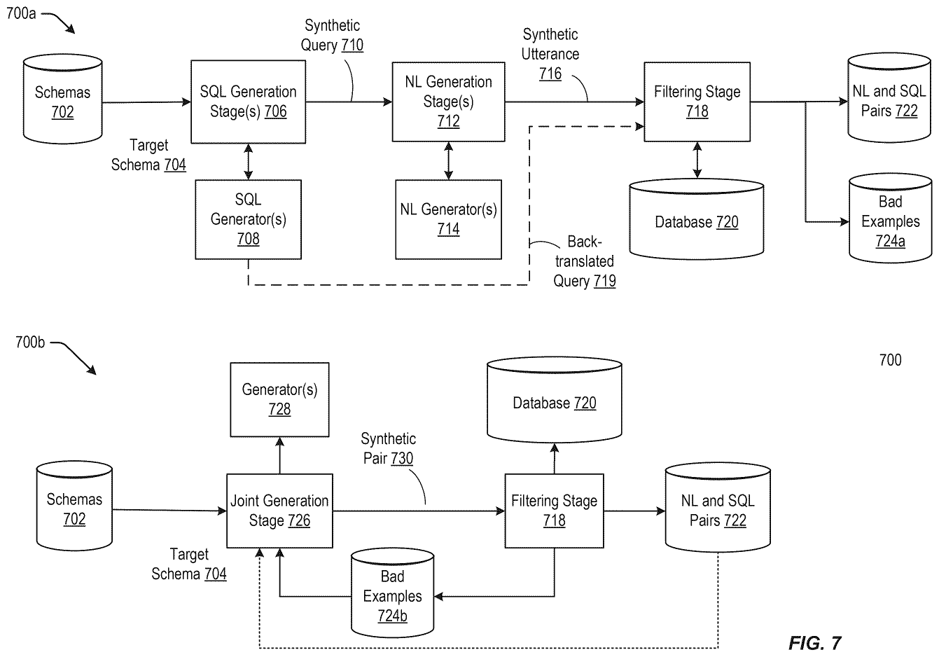

FIG. 7 is an illustration of an NL and SQL generation subsystem for generating synthetic NL utterances and SQL queries that can be included in NL2SQL fine-tuning training examples. As illustrated in FIG. 7, the NL and SQL generation subsystem 700 may implement different solutions for generating synthetic NL utterances and SQL queries. A sequential generation system 700a illustrates an example system for generating NL utterances and SQL queries sequentially. A joint generation system 700b illustrates an example system for generating NL utterances and SQL queries using a combined generation stage. The sequential generation system 700a and joint generation system 700b may be used to implement a NL and SQL generation stage 514 as described in FIG. 5 using software only, hardware only, firmware only, or any combination of software, hardware, and/or firmware.

The sequential generation system 700a can be a set of schemas 702. The schemas 702 may be synthetic database schemas generated by a database schema generator (e.g., by the schema generation stage 506 of FIG. 5). A target schema 704 is provided to a SQL generation stage 706. The target schema 704 may contain many tables, while a SQL query may only be directed towards a subset of the tables. In some examples, to target SQL query generation for important tables within the target schema 704, the SQL generation stage 706 may select a subset of tables from the target schema 704 to be included in to include in the generation. The SQL generation stage 706 may perform a random sampling of a subset of tables in the target schema 704. The random sample of tables can be selected by selecting a first table from all potential tables based on their degrees (e.g., how many other tables are connected to it) and selecting tables from a neighborhood of tables of the currently selected table. The sampling steps may ensure that selected tables are central or highly-connected tables, which may be indicate important areas of the database schema, are selected.

The SQL generation stage 706 can construct a prompt to provide to one or more SQL generator(s) 708. The SQL generator(s) 708 can be one or more generative models (e.g., LLMs). The SQL generation prompt can include the target schema 704 from the set of synthetic schemas is provided to SQL generator(s) 708. In some examples, the SQL generation prompt can include a SQL generation pattern. The SQL generation pattern can be or can include instructions for generating various types of queries including but not limited to SELECT WHERE queries, GROUP BY queries, JOIN queries, or any combination thereof. The SQL generation pattern may be specific to a user, domain, or otherwise. The SQL generation pattern may guide each SQL generator 708 to follow the SQL pattern when generating SQL queries. An example generation pattern is below:

```
SQL_GENERATION_PATTERNS = [
{
  ′pattern_name′: ′SELECT_WHERE′,
  ′num_tables′: 1,
  ′prompt′:
  ″″″- The SQL query should be quoted within ‘‘‘ to separate it from other information
  texts.
  - The SQL query should be a simple SELECT statement with a WHERE clause to filter
  data rows on some conditions.
  - Use inequality operations for numeric columns such as costs, amounts, revenues,
  percentage, ...
  - Don't use ″SELECT *″, just return at most {MAX_COLUMN} columns.
  - Don't use exact equality or set comparison for numeric columns such as costs,
  amounts, revenues, percentage...
  - Don't provide any explanation.
  ″″″
},
{
  ′pattern_name′: ′GROUP_BY′,
  ′num_tables′: 1,
  ′prompt′:
  ″″″- The SQL query should be quoted within ‘‘‘ to separate it from other information
  texts.
  - You need to include the ″GROUP BY″ operator in the SQL query.
  - Use inequality operations for numeric columns such as costs, amounts, revenues,
  percentage, ...
  - Don't use ″SELECT *″, just return at most {MAX_COLUMN} columns.
  - Don't use exact equality or set comparison for numeric columns such as costs,
  amounts, revenues, percentage...
  - Don't use ″GROUP BY″ on numeric columns.
  - Don't use ″COUNT″ aggregation on numeric columns.
  - Don't provide any explanation.
  ″″″
},
  ...
```

The SQL generation stage 706 can construct and generate a SQL generation prompt including a SQL generation pattern. An example SQL generation prompt is below:

“You are an Oracle SQL query generator. You are provided with some table schemas in
the [SCHEMA] section.
Please follow the below instructions during the Oracle SQL generation:
{PATTERN}
Generate a Oracle SQL query for the below Oracle database tables?
[SCHEMA]:
{SCHEMA}
[Oracle SQL]:
”

In some examples, the SQL generation stage 706 may construct a prompt including business logic (e.g., as generated by the description and business logic stage 512 of FIG. 5) to further target SQL generation. An example SQL generation prompt using business logic may be as follows:

Given the database schema for retail complaints and some business rules for some tables,
you are asked to generate a SQL query that use some of
these business rules.
If a derived column is used, use its formula directly in the generated SQL query.
You only need to generate one SQL query.
The generated SQL query should be open with ‘‘‘sql and close with ‘‘‘.
Below is the database schema:
{DATABASE_SCHEMA}
Business Rules:
(BUSINESS_LOGIC}
SQLite SQL:
Given the database schema for retail complaints, some business rules for some tables, and
a SQL query, you are asked to the corresponding natural
language question for the SQL query.
Please follow the below instructions during the natural language question generation:
- The question should be precise, i.e. being equivalent to the SQL query semantically.
- The question should be succinct.
- Using information on Business Rules section to correctly convert the business rules
used in the SQL query to natural language.
Below is the database schema:
{DATABASE_SCHEMA}
Business Rules:
{BUSINESS_LOGIC}
SQLite SQL:
{GENERATED_SQL}
Question:

The SQL generator(s) 708 generate a synthetic query 710 based on the SQL generation prompt. The synthetic query 710 is provided to an NL generation stage 712. The NL generation stage 712 can generate an NL generation prompt to provide to one or more NL generator(s) 714. The NL generator(s) 714 can be generative models (e.g., LLMs) and may be the same models or different models as the SQL generator(s) 708. The NL generation prompt can include tables and columns appear in in the synthetic SQL statement. Below is a nonlimiting example NL generation prompt:

“““<s>[INST] You are a SQL to natural language question converter. You are provided
with some table schemas in the [SCHEMA] section and a SQL query.
Please follow the below instructions during the natural language question generation:
- The question should be precise, i.e. being equivalent to the SQL query semantically.
- Use the column description rather the raw column name when creating the question.
- The question should be succinct.
- Don't make up units of measurement such as length, distance, weight, height, density,
time, temperature, speed to any numeric value if these units are
not provided explicitly in SCHEMA and SQL Query sections.
- Don't make up currency codes to any numeric value if these currency codes are not
provided explicitly in SCHEMA and SQL Query sections.
Generate a natural language question for the following database tables and the SQL
query:
[SCHEMA]:
{SCHEMA}
[SQL Query]:
{SQL_QUERY}
[Natural Language Question]:
[/INST]
”””

In some examples, the sequential generation system 700a includes a filtering stage 718. The filtering stage 718 can include an execution-based verification of the synthetic query 710 and synthetic utterance 716. The synthetic utterance 716 may be provided to a generative model (e.g., SQL generator(s) 708) to generate a back-translated query 719. The filtering stage 718 may generate a prompt guiding the generative models to generate an SQL query that corresponds to the synthetic utterance 716. The back-translated query 719 can be SQL query corresponding to the synthetic utterance 716. The back-translated query 719 and the synthetic query 710 are executed on a database 720. In some examples, the database 720 is populated with synthetic content as described in FIG. 5 (e.g., inserting synthetic database content 516 into the database 518).

The results of executing the back-translated query 719 are compared with the results of executing the synthetic query 710. A match comparison (e.g., as described at block 416 in FIG. 4) may be performed on the query results to determine whether the results match. If the results match, the filtering stage 718 may determine the synthetic query 710 and synthetic utterance 716 are a good pair. The synthetic query 710 and synthetic utterance 716 can be added as a pair to an NL and SQL pairs 722 set. If the results do not match, the filtering stage 718 may determine the synthetic query 710 and synthetic utterance 716 are a bad pair. In such cases, the synthetic query 710, synthetic utterance 716, or a combination of the synthetic query 710 and synthetic utterance 716 can be added to a set of bad examples 724a.

The joint generation system 700b illustrates an exemplary joint SQL and NL generation system. A target schema 704 is accessed from a set of schemas 702 and provided to a joint generation stage 726. The joint generation stage 726 may generate a prompt to provide to one or more generator(s) 728 to generate a synthetic pair 730 including a synthetic NL utterance and a synthetic SQL query. The generator(s) 728 can be generative models (e.g., LLMs). The joint generation stage 726 may access a joint generation prompt template and perform a slot-filling process to generate the joint generation prompt. The joint generation prompt can include the target schema 704 and a description of a target SQL analytics generation pattern. The SQL analytics generation pattern can include a description of types of statements a model may not perform well on and ways to structure a synthetic SQL query (e.g., types of clauses, keywords, etc. to include in a generated SQL statement). An example generation pattern description is as follows:

The model does not produce an aggregation in the SELECT clause when the question
asks for a GROUP BY HAVING clause. The correct SQL should
have the column in group by as well as an aggregation in the SELECT clause.
The model should also predict a mix of aggregation functions like SUM, AVG, COUNT.
The query should not use id columns in GROUP BY.
The query should also have a HAVING clause. The query should be a GROUP BY ...
HAVING ... query.
Please try to use difference columns for every example.
Please try to include a WHERE clause filter in your example

In some examples, the joint generation prompt further includes in-context examples of natural language utterances and/or SQL queries. The in-context examples can include a good NL utterance, bad NL utterance, good SQL query, bad SQL query, or any combination thereof. In-context examples may be retrieved from a set of bad examples 724b and/or NL and SQL pairs 722. Bad examples 724b may be determined by the filtering stage 718 based on the synthetic pair 730 generated by the joint generation stage 726. In some examples, the joint generation system 700b is executed after the sequential generation system 700a is executed, and bad examples 724b may be the bad examples 724a identified by the sequential generation system 700a. An example of in context-examples is below:

Question: Show me the accounts over 5M
Good SQL:
SELECT ACCOUNT, SUM(ACTUAL_REVENUE) AS TOTAL_REVENUE
FROM MOVIESTREAM.PROJECTS
GROUP BY ACCOUNT
HAVING SUM(ACTUAL_REVENUE) > 5000000
Bad SQL:
SELECT ACCOUNT FROM MOVIE_STREAM_PROJECTS GROUP BY ACCOUNT
HAVING SUM(ACTUAL_REVENUE) > 5000000

The synthetic pair 730 may be processed by the filtering stage 718. The filtering stage 718 can generate a back-translated query 719 using the one or more generator(s) 728 to generate the back-translated query 719. The filtering stage 718 may perform execution-based validation using the database 720 as described above with respect to the sequential generation system 700a. The filtering stage may also perform LLM-based validation on the example pairs to determine examples that should be kept in cases where query results are empty sets. The retained synthetic pairs may be added to NL and SQL pairs 722 dataset and discarded pairs may be added to the set of bad examples 724b. The NL and SQL pairs 722 can be included in a training example to fine-tune an NL2SQL model. The synthetic NL utterance can be included in a prompt associated with training example, and the synthetic SQL query can be included as the gold SQL query in the training example.

### Curated Rehearsal Training

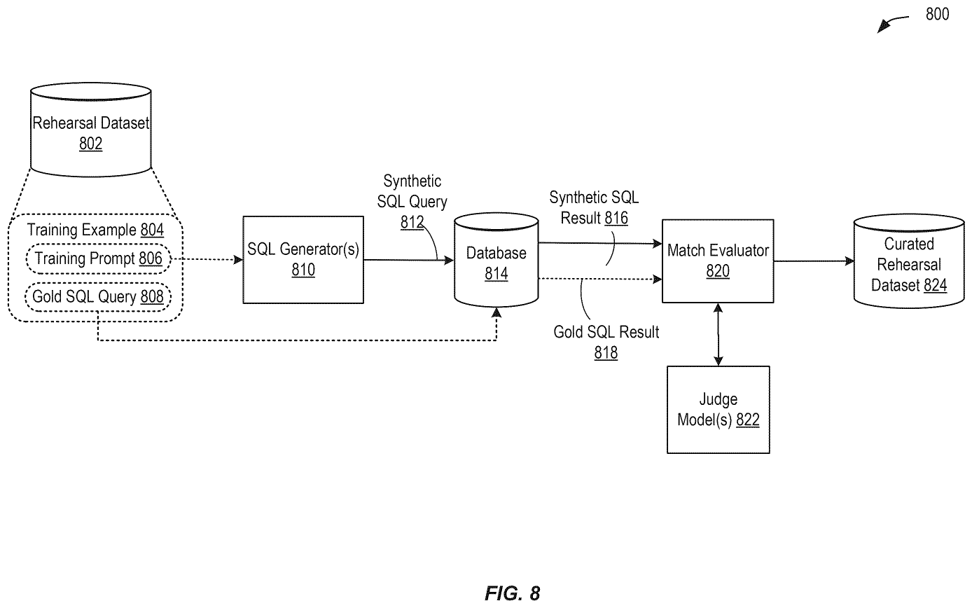

FIG. 8 is a simplified block diagram illustrating aspects of a rehearsal curation system 800 for generating a curated rehearsal training dataset for fine-tuning an NL2SQL model with rehearsal training examples. The rehearsal curation system 800 can generate a curated rehearsal dataset by identifying a subset of rehearsal examples from a rehearsal dataset that can be used to train an NL2SQL model. The rehearsal curation system 800 may identify the subset of rehearsal examples by performing execution-based validation of SQL queries (as described with respect to synthetic SQL queries in FIG. 7).

The rehearsal curation system 800 can access a rehearsal dataset 802. The rehearsal dataset 802 includes training examples(s) 804 that can be used to train an NL2SQL model. Each training example 804 contains a training prompt 806 and a gold SQL query 808. The training prompt 806 can include a database schema and a natural language utterance associated with the database schema. The rehearsal dataset 802 may include training examples that were previously used to train an NL2SQL model (e.g., a pre-trained LLM). In some embodiments, the rehearsal dataset 802 is a publicly available training dataset (e.g., Spider, etc.). In some embodiments, training data used to train a pre-trained LLM is not be available, and the rehearsal dataset 802 can include synthetic training examples generated for tasks already covered by an NL2SQL model. Synthetic rehearsal training examples may be generated using the synthetic data generation system 500 as described in FIG. 5. In such examples, domain data 502 may include domain identifiers for domains for which the NL2SQL model has high accuracy.

The training prompt 806 is provided to one or more SQL generator(s) 810 to generate a synthetic SQL query 812. The SQL generator(s) 810 can be one or more generative models (e.g., LLMs). The synthetic SQL query 812 generated by the SQL generator(s) 810 can correspond to a natural language utterance included in the training prompt 806. The synthetic SQL query 812 and the gold SQL query 808 are each executed on a database 814. The queries may be executed via a SQL engine as described in FIG. 4 (e.g., block 410 of FIG. 4). The database 814 can be populated with data corresponding to a database schema in the training prompt 806. In examples where the rehearsal dataset 802 includes real training examples (e.g., from a publicly available dataset), the database 814 may be populated with real data associated with one or more database schemas included in the training prompt 806. In examples where the rehearsal dataset 802 is a synthetic dataset, the database 814 may be generated and populated with data as described in FIG. 5 (e.g., by content generation stage 510). Executing the synthetic SQL result 816 on the database 814 produces a synthetic SQL result 816 and executing the gold SQL query 808 on the database 814 produces a gold SQL result 818. The synthetic SQL result 816 and the gold SQL result 818 can each be or can include one or more values (e.g., table values, row values, column values, etc.) from the database 814. In some cases, the synthetic SQL result 816 and/or the gold SQL result 818 can be an empty set.

The synthetic SQL result 816 and the gold SQL result 818 are evaluated by a match evaluator 820. The match evaluator 820 can determine whether the synthetic SQL result 816 and the gold SQL result 818 match. Two results may match if they are or include the same values including, but not limited to, numeric value, string value, table name, row name, table set, etc. In some examples, a threshold can be determined for numeric values and two results can be considered a match if the difference between the numeric values is less than the threshold (e.g., within 0.1, 1, 5, etc.). In some examples, the match evaluator 820 can determine a match by identifying a similarity score (e.g., by performing semantic matching) of the synthetic SQL result 816 and the gold SQL result 818. In some examples, the match evaluator 820 can determine a match if the synthetic SQL result 816 is substantially the gold SQL result 818. If the match evaluator 820 determines the synthetic SQL result 816 and the gold SQL result 818 match, the training example 804 can be added to a curated rehearsal dataset 824. The curated rehearsal dataset 824 may be a subset of the rehearsal dataset 802. If the match evaluator 820 determines the synthetic SQL result 816 and the gold SQL result 818 do not match, the training example 804 is not added to the curated rehearsal dataset 824. In some examples, the match evaluator 820 may be implemented as described in FIG. 4 (e.g., at blocks 412 and 416 of FIG. 4).

In some examples, both the synthetic SQL result 816 and the gold SQL result 818 are empty sets. As an example, the synthetic SQL query 812 and the gold SQL query 808 can be SELECT WHERE statements, but no entries within the database 814 may match a condition included in the SELECT WHERE statement. However, though the synthetic SQL result 816 and the gold SQL result 818 match as empty sets, the cause of the empty set result may or may not be correct or intended behavior. For example, a condition included in the SELECT WHERE statement may not be related to a domain or task covered by the training example 804 and the gold SQL query 808 should not be used to train an NL2SQL model. In other examples, the condition in the SELECT WHERE statement may be correct and no data matches the condition, but the gold SQL query 808 can be used to train an NL2SQL model. In cases where the synthetic SQL result 816 and the gold SQL result 818 are both empty sets, judge model(s) 822 may be used to determine the quality of the gold SQL query 808, synthetic SQL query 812, or any combination thereof. The judge model(s) 822 can be one or more generative models (e.g., LLMs). The judge model(s) 822 may determine if the synthetic SQL query 812 and the gold SQL query 808 are similar. The judge model(s) 822 may be prompted to judge the criteria including, but not limited to, compliance with SQL dialect standards, completeness and detail, correctness, readability and maintainability, scalability, quality of NL question, etc. The match evaluator 820 may construct a prompt for the judge model(s) 822 using a slot-filling process. The prompt can include instructions on criteria the synthetic SQL query 812 and gold SQL query 808 should be judged on. An example prompt for the judge model(s) 822 can be as follows:

```
Given an input Question and a {sql dialect} query of the question, prepare an assessment
of the Question and SQL
  Query according to the following criteria. These are the metrics:
  Criterion A: Completeness and Detail Instructions:
  - Award 1 star if the SQL output is incomplete, missing significant portions
  required for the task.
  - Award 2 stars if the SQL output is somewhat complete but lacks important
  details or components.
  - Award 3 stars if the output is mostly complete, with all major components
  present but missing some minor details.
  - Award 4 stars if the output is complete, with all components detailed adequately,
  though it could be enhanced with more nuanced details.
  - Award 5 stars if the output is exceptionally complete and detailed, exceeding
  expectations with comprehensive coverage of all task components.
  Criterion B: SQL Correctness (Does the SQL query provide the correct result?)
  - Award 1 star if the query does not execute or returns incorrect results; logic does
  not align with intended operations.
  - Award 2 stars if the query executes but returns partially correct results,
  significant errors present; some logical discrepancies present.
  - Award 3 stars if the query returns mostly correct results but with minor
  inaccuracies or omissions; logic generally reflects intended operations.
  - Award 4 stars if the query returns correct results with negligible issues not
  affecting the main output; logic aligns well with intended outcomes.
  - Award 5 stars if the query executes flawlessly, returning accurate and complete
  results as per the requirement; logic perfectly aligns with intended operations.
  ...
  ## Format
  Please estimate the stars of these metrics:
  - completeness and detail - (1 to 5)
  - SQL Correctness - (1 to 5)
  - Readability and Maintainability - (1 to 5)
  - Scalability - (1 to 5)
  - Compliance with Standards - (1 to 5)
  - Quality of the Question - (1 to 5)
  Do not change the name of the metrics. The {sql_dialect} SQL schema is
  provided below.
  # The SQL Schema is provided here:
  $sql_schema
  # The natural language question is provided as:
  $question
  # The sql to judge is as follows:
  $gold_sql
  # The output response format:
  The output must have following items in an orderly manner:
  - The final star ratings of criterions in a listwise manner
  - The final star ratings of criterions in a json format
  - Explain the output of the LLM in full details. Do not miss any criteria.
```

The judge model(s) 822 may generate a score for one or more criteria. Examples where the judge model(s) 822 determine a score that meets a score threshold for retaining a rehearsal training example may be added to the curated rehearsal dataset 824. The score threshold for each criterion may vary. For example, a threshold for compliance with standards and completeness may be a score of 5 and a threshold of any remaining criteria may be 4.

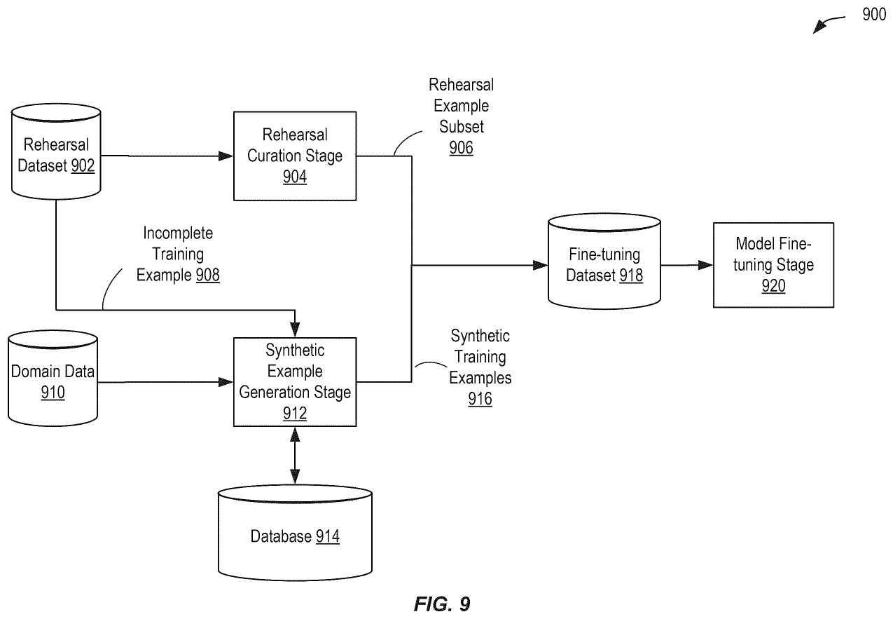

FIG. 9 is a simplified block diagram illustrating aspects of an exemplary rehearsal and synthetic fine-tuning data generation system 900. The rehearsal and synthetic fine-tuning data generation system 900 can include one or more components of the synthetic data generation system 500 of FIG. 5 and/or the rehearsal curation system 800 of FIG. 8. As depicted in FIG. 9, the rehearsal and synthetic fine-tuning data generation system 900 includes a rehearsal curation stage 904 and a synthetic example generation stage 912. Each stage should be understood to be an execution of one or more processes and/or programs implemented with software, hardware, and/or firmware within a system (e.g., as described with respect to FIGS. 11-15).

A rehearsal dataset 902 (e.g., rehearsal dataset 802 of FIG. 8) is provided to a rehearsal curation stage 904. The rehearsal curation stage 904 can be implemented by the rehearsal curation system 800 of FIG. 8. The rehearsal curation stage 904 can select a rehearsal example subset 906 from the rehearsal dataset 902. The rehearsal dataset 902 can include training examples on domains or tasks a model has previously been trained upon to reinforce model accuracy on the specific domain. The rehearsal curation stage 904 can include generating a synthetic SQL query based on a prompt included in a training example using one or more LLMs and performing execution-based validation by executing the synthetic SQL query and a gold SQL query on a database and determining whether the execution results match.

A synthetic example generation stage 912 can access domain data 910 (e.g., domain data 502 of FIG. 5) to generate synthetic training examples 916. The synthetic example generation stage 912 can be implemented as described in FIG. 5 (e.g., by the synthetic data generation system 500) and can include subcomponents including, but not limited to, a synthetic schema generation stage, content generation stage, description and business logic stage, NL and SQL generation stage, or any combination thereof. A synthetic example generated by the synthetic example generation stage 912 can include a prompt and a synthetic SQL completion. The prompt can include a synthetic database schema, synthetic natural language utterance, a schema description, business process description, target instruction, etc. One or more components of the prompt and/or SQL completion can be generated by a generative model (e.g., an LLM). Generated SQL queries may be validated based on an execution of the SQL queries on a database 914 (e.g., database 518). The database 914 may be populated with synthetic database content as described in FIG. 5.

In some examples, the rehearsal dataset 902 can include incomplete training examples 908. An incomplete training example may be missing one or more components such as a properly formed database schema, complete natural language utterance, complete SQL completion, or any combination thereof. As an example, an incomplete training example can include a prompt with a database schema and SQL generation instructions but may not include a natural language utterance and gold SQL query. In such examples, the incomplete training example 908 may be provided to the synthetic example generation stage 912. For such examples, synthetic generation may only utilize a subset of the components of the synthetic example generation stage 912 (e.g., the NL and SQL generation stage 514) to generate specific parts of the training example. As an example, if a training example is associated with a database schema and a database is populated with contents related to the database schema, the synthetic example generation stage may only generate the synthetic SQL and natural language questions needed for a synthetic training example. A database 914 in such cases may be populated with real database content in addition to or instead of to synthetic content as generated by a database content generator (e.g., DB content generator(s) 513 of FIG. 5). The synthetic example generation stage may implement different systems of synthetic NL and SQL generation based on the incompleteness of the training example. For example, a joint generation system 700b of FIG. 7 may be used for examples where more targeted NL question and SQL query pairs are needed.

In some examples, the synthetic example generation stage 912 can generate an entire rehearsal training example included in the rehearsal dataset 902. In such examples, rehearsal data may not be available for a specific NL2SQL model and/or domain, and the synthetic example generation stage 912 may select a domain for which an NL2SQL model already achieves high accuracy.

The selected rehearsal training examples and the synthetic examples are added to a fine-tuning dataset 918 that can be used during a model fine-tuning stage 920. Including a combination of rehearsal training examples and synthetic training examples in the fine-tuning dataset 918 can ensure a trained model performs well on a target task and/or domain without reducing performance for other tasks and domains. This can prevent catastrophic forgetting by reinforcing previous knowledge. Fine-tuning may be performed as described in FIGS. 4-5. The model fine-tuning stage 920 may generate a fine-tuned model (e.g., as described in FIG. 5).

### Illustrative Method

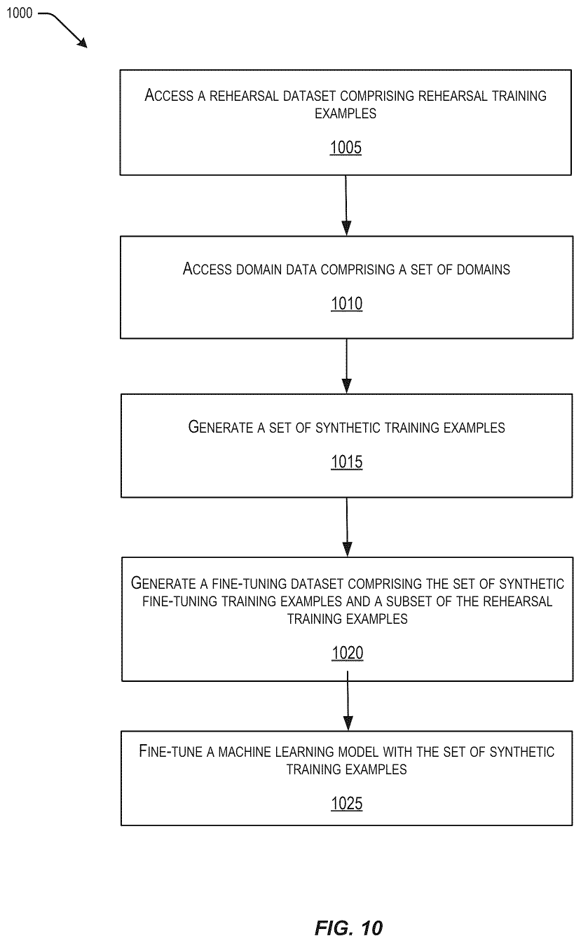

FIG. 10 is a flowchart illustrating a process 1000 for generating a fine-tuning dataset including augmented training examples to train a machine learning model for transforming natural language to logical form, according to various embodiments. The processing depicted in FIG. 10 may be implemented in software (e.g., code, instructions, a program) executed by one or more processing units (e.g., one or more processors, cores) of the respective systems, hardware, or combinations thereof described throughout. The software may be stored on a non-transitory storage medium (e.g., on a memory device). Although the methods presented in FIG. 10 depict the various processing steps occurring in a particular sequence or order, this is not intended to be limiting. In certain alternative embodiments, the steps may be performed in parallel and/or in a different order. In certain embodiments, such as in the embodiments depicted in FIGS. 1-9, the processing depicted in FIG. 10 may be performed by a synthetic data generation system 500, as described with respect to FIG. 5, and/or a training, testing, and deployment or production system or subsystem, as described with respect to FIG. 4.

At optional block 1005, a rehearsal dataset (e.g., rehearsal dataset 802) comprising rehearsal training examples may be accessed. The rehearsal dataset can include training examples previously used to train a machine learning model. In some examples, the rehearsal dataset may be generated by one or more generative models. Each rehearsal training example of the rehearsal training examples can include a training prompt and a gold logical form.

At block 1010, domain data (e.g., domain data 502) comprising a set of domain identifiers is accessed. In some examples, the domain data can include domain identifiers for target domains and one or more keywords associated with each target domain.

At block 1015, a set of synthetic training examples (e.g., synthetic fine-tuning dataset 522) is generated. Generating the set of synthetic training examples can include performing an iterative process. The iterative process can include generating, by a first generative model (e.g., a generative model) a synthetic database schema (e.g., synthetic database schema 508) based on the domain data, where the synthetic database schema comprises one or more tables; generating, by a second generative model (e.g., DB content generator(s) 513), synthetic database content (e.g., synthetic database content 516) associated with the synthetic database schema; generating, by a third generative model, a synthetic natural language utterance and a synthetic logical form based on the synthetic database schema and the synthetic database content; and generating a synthetic training example of the set of synthetic training examples to include the synthetic database schema, the synthetic natural language utterance, and the synthetic logical form. In some examples, a synthetic training example can include a schema description and/or a business logic. In some examples, the synthetic database schema can include a schema and a description of the schema. In some examples, the synthetic natural language utterance and the synthetic logical form are generated based on a real database schema and real database content.

In some embodiments, generating the synthetic database schema includes: selecting a domain identifier from the set of domain identifiers; identifying one or more keywords (e.g., keywords 606) associated with the domain identifier, wherein the domain data includes the one or more keywords; generating a business process description (e.g., business process 610) based on the domain identifier and the one or more keywords; generating a database schema generation prompt comprising the domain identifier, the one or more keywords, and the business process description; and providing the database schema generation prompt to the first generative model (e.g., schema generator(s) 616).

In some embodiments, generating the synthetic database content includes: identifying one or more table relationships based on the synthetic database schema (e.g., identifying a foreign key); determining an order of the one or more tables based on the one or more table relationships; and generating table content for each table of the one or more tables based on the order, the one or more table relationships, and the synthetic database schema, wherein the table content is (i) random, (ii) extracted from a prior table, or (iii) any combination thereof. In some examples, the order of the one or more tables can be determined by generating a graphical representation of the one or more tables.

In some embodiments, generating the synthetic natural language utterance and the synthetic logical form includes: generating, by the third generative model, the synthetic logical form (e.g., synthetic query 710) based on the synthetic database schema comprising the one or more tables or only a subset of the one or more tables, and a gold logical form pattern (e.g., SQL generation pattern); generating, by the third generative model, the synthetic natural language utterance (e.g., synthetic utterance 716) based on the synthetic logical form; generating, by the third generative model, a back-translated logical form (e.g., back-translated query 719) based on the synthetic natural language utterance; executing the synthetic logical form and the back-translated logical form on a test database (e.g., database 720) including the synthetic database content, wherein executing the synthetic logical form generates a synthetic query result and wherein executing the back-translated logical form generates a back-translated query result; determining whether the synthetic query result corresponds with the back-translated query result; and in accordance with determining that the synthetic query result does not correspond with the back-translated query result, discarding the synthetic logical form and the synthetic natural language utterance. In some examples, the synthetic logical form and the synthetic natural language utterance are added to a set of bad examples in accordance with determining the synthetic query result does not correspond with the back-translated query result.

In some embodiments, generating the synthetic natural language utterance and the synthetic logical form includes: generating a joint generation prompt comprising a target logical form pattern (e.g., target SQL analytics generation pattern) a first logical form example, and a second logical form example; and providing the joint generation prompt to the third or a fourth generative model to generate the synthetic natural language utterance and the synthetic logical form.

In some embodiments, the iterative process can further include generating, by a fifth generative model, a schema description based on: (i) a domain description, (ii) a domain keyword, (iii) the synthetic database schema, (iv) a set of target columns, or (v) any combination thereof; and generating, by the fifth generative model, a business logic rule based on the synthetic database schema, wherein the schema description and the business logic rule are included in one or more prompts, and wherein the one or more prompts are provided to the third generative model to generate the synthetic natural language utterance and the synthetic logical form. In some examples, the schema description and business logic generated by the fifth generative model are included in the synthetic training example.

In some embodiments, the first generative model, the second generative model, the third generative model, the fourth generative model, and the fifth generative model are all the same model, are all different models, or some are the same model, and some are different models.

At optional block 1020, a fine-tuning dataset comprising the set of synthetic fine-tuning training examples and a subset of the rehearsal training examples (e.g., curated rehearsal dataset 824) may be generated. In some examples, the subset of the rehearsal training examples is determined by for each rehearsal training example: generating, by a fourth generative model, a synthetic rehearsal logical form based on the training prompt (e.g., synthetic SQL query 812); executing the synthetic rehearsal logical form and the gold logical form (e.g., gold SQL query 808) on a database (e.g., database 814), wherein executing the synthetic rehearsal logical form generates a synthetic rehearsal query result (e.g., synthetic SQL result 816) and wherein executing the gold logical form generates a rehearsal query result (e.g., gold SQL result 818); determining whether the synthetic rehearsal query result corresponds with the rehearsal query result; and in accordance with determining that the synthetic rehearsal query result corresponds with the rehearsal query result, adding the rehearsal training example to the subset of the rehearsal training examples.

At block 1025, a machine learning model is fine-tuned with the set of synthetic training examples (e.g., synthetic fine-tuning dataset 522) to generate a fine-tuned machine learning model. In some examples, the machine learning model is fine-tuned with the fine-tuning dataset including the subset of rehearsal training examples (e.g., fine-tuning dataset 918). In some implementations, the fine-tuned machine learning model is provided (e.g., deployed) to a natural language to logical form system, where it can be used to execute processes for converting a natural language utterance to logical form (which can be used as part of a larger system such as a digital assistant or chatbot). The processes can include receiving an input from a user, the input comprising a natural language component; providing, to the fine-tuned machine learning model, a prompt comprising an instruction, a database schema associated with the natural language component, and an utterance associated with the natural language component; receiving, from the fine-tuned machine learning model, a logical form corresponding to the utterance based at least in part on the prompt; executing the logical form on a database to obtain a query result; and providing the query result to the user.

As used herein, when an action is “based on” something, this means the action is based at least in part on at least a part of the something.

As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

### Illustrative System

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

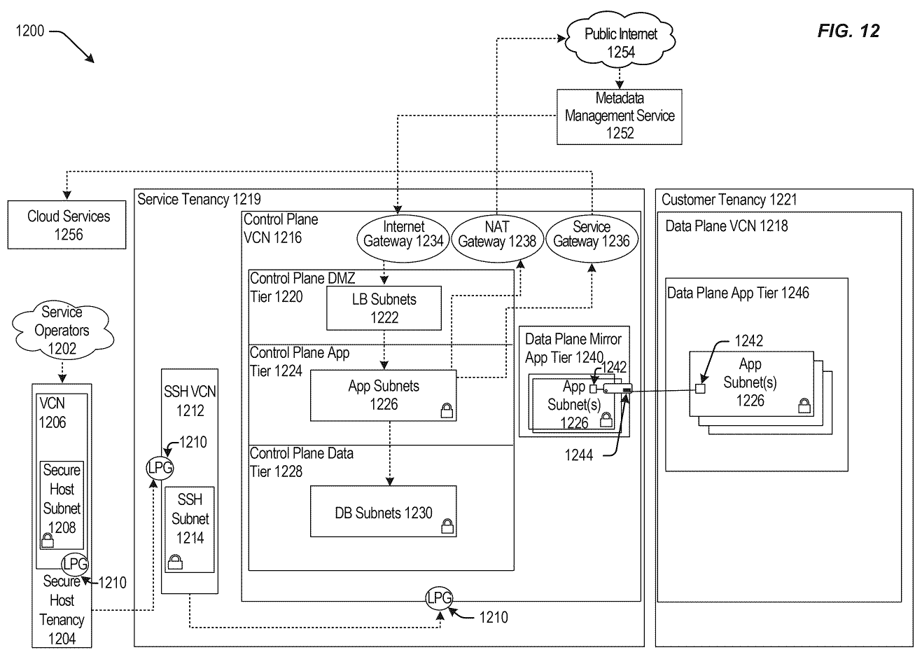

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

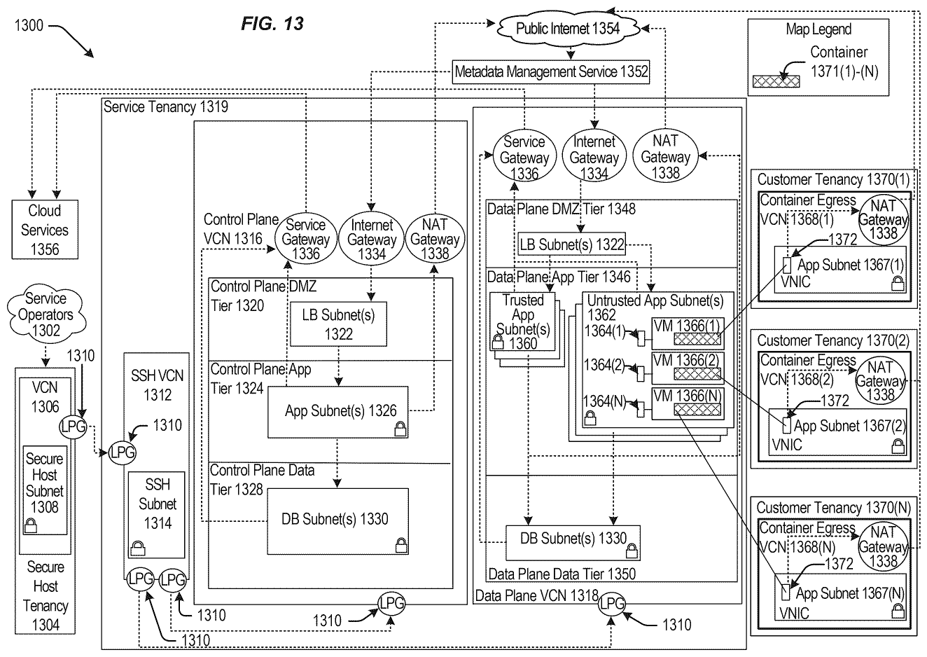

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

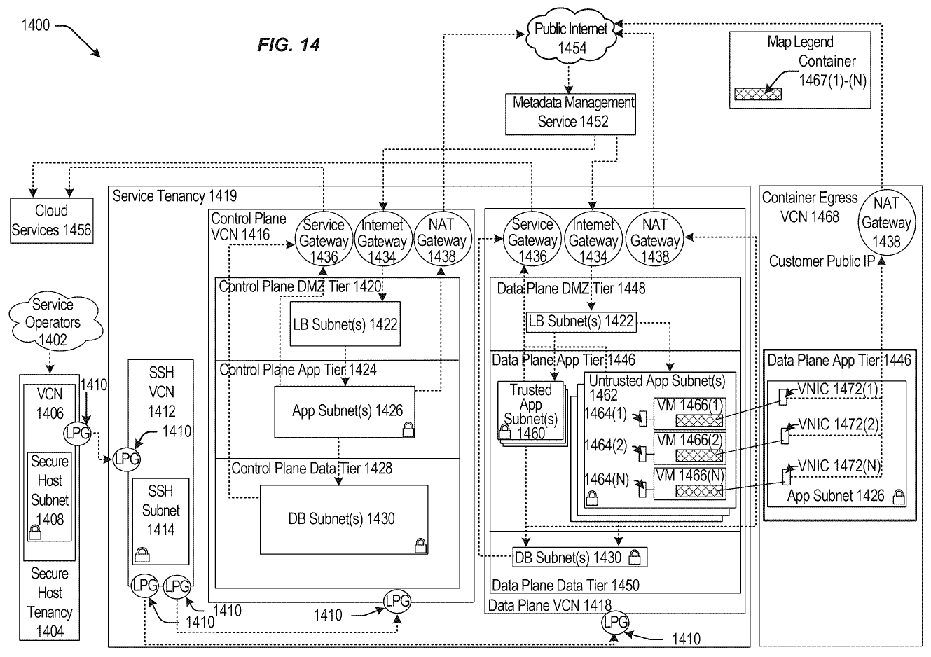

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

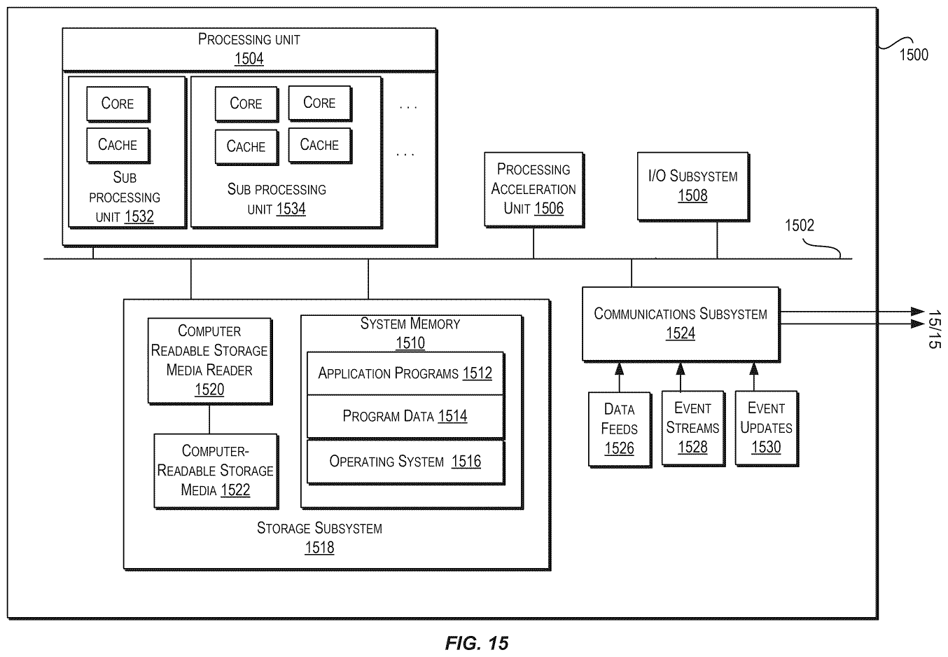

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A computer-implemented method comprising:
accessing domain data comprising a set of domain identifiers;
generating a set of synthetic training examples, wherein generating the set of synthetic training examples comprises performing an iterative process, and wherein the iterative process comprises:
generating, by a first generative model, a synthetic database schema based on the domain data, wherein the synthetic database schema comprises one or more tables,
generating, by a second generative model, synthetic database content associated with the synthetic database schema,
generating, by a third generative model, a synthetic natural language utterance and a synthetic logical form based on the synthetic database schema and the synthetic database content, and
generating a synthetic training example of the set of synthetic training examples to include the synthetic database schema, the synthetic natural language utterance, and the synthetic logical form; and
fine-tuning a machine learning model with the set of synthetic training examples to generate a fine-tuned machine learning model.

2. The computer-implemented method of claim 1, further comprising:
accessing a rehearsal dataset comprising rehearsal training examples; and
generating a fine-tuning dataset comprising the set of synthetic fine-tuning training examples and a subset of the rehearsal training examples,
wherein the machine learning model is fine-tuned using the fine-tuning dataset.

3. The computer-implemented method of claim 2, wherein each rehearsal training example of the rehearsal training examples includes a training prompt and a gold logical form, and wherein the subset of the rehearsal training examples is determined by, for each rehearsal training example:
generating, by a fourth generative model, a synthetic rehearsal logical form based on the training prompt;
executing the synthetic rehearsal logical form and the gold logical form on a database, wherein executing the synthetic rehearsal logical form generates a synthetic rehearsal query result and wherein executing the gold logical form generates a rehearsal query result;
determining whether the synthetic rehearsal query result corresponds with the rehearsal query result; and
in accordance with determining that the synthetic rehearsal query result corresponds with the rehearsal query result, adding the rehearsal training example to the subset of the rehearsal training examples.

4. The computer-implemented method of claim 1, wherein generating the synthetic database schema comprises:
selecting a domain identifier from the set of domain identifiers;
identifying one or more keywords associated with the domain identifier, wherein the domain data includes the one or more keywords;
generating a business process description based on the domain identifier and the one or more keywords;
generating a database schema generation prompt comprising the domain identifier, the one or more keywords, and the business process description; and
providing the database schema generation prompt to the first generative model.

5. The computer-implemented method of claim 1, wherein generating the synthetic database content comprises:
identifying one or more table relationships based on the synthetic database schema;
determining an order of the one or more tables based on the one or more table relationships; and
generating table content for each table of the one or more tables based on the order, the one or more table relationships, and the synthetic database schema, wherein the table content is (i) random, (ii) extracted from a prior table, or (iii) any combination thereof.

6. The computer-implemented method of claim 1, wherein generating the synthetic natural language utterance and the synthetic logical form comprises:
generating, by the third generative model, the synthetic logical form based on the synthetic database schema comprising the one or more tables or only a subset of the one or more tables, and a gold logical form pattern;
generating, by the third generative model, the synthetic natural language utterance based on the synthetic logical form;
generating, by the third generative model, a back-translated logical form based on the synthetic natural language utterance;
executing the synthetic logical form and the back-translated logical form on a test database including the synthetic database content, wherein executing the synthetic logical form generates a synthetic query result and wherein executing the back-translated logical form generates a back-translated query result;
determining whether the synthetic query result corresponds with the back-translated query result; and
in accordance with determining that the synthetic query result does not correspond with the back-translated query result, discarding the synthetic logical form and the synthetic natural language utterance.

7. The computer-implemented method of claim 1, wherein generating the synthetic natural language utterance and the synthetic logical form comprises:
generating a joint generation prompt comprising a target logical form pattern, a first logical form example, and a second logical form example; and
providing the joint generation prompt to the third or a fourth generative model to generate the synthetic natural language utterance and the synthetic logical form.

8. The computer-implemented method of claim 1, further comprising:
generating, by a fifth generative model, a schema description based on: (i) a domain description, (ii) a domain keyword, (iii) the synthetic database schema, (iv) a set of target columns, or (v) any combination thereof; and
generating, by the fifth generative model, a business logic rule based on the synthetic database schema,
wherein the schema description and the business logic rule are included in one or more prompts, and wherein the one or more prompts are provided to the third generative model to generate the synthetic natural language utterance and the synthetic logical form.

9. The computer-implemented method of claim 1, wherein the synthetic natural language utterance and the synthetic logical form are generated based on a real database schema and real database content.

10. The computer-implemented method of claim 1, further comprising:
receiving an input from a user, the input comprising a natural language component;
providing, to the fine-tuned machine learning model, a prompt comprising an instruction, a database schema associated with the natural language component, and an utterance associated with the natural language component;
receiving, from the fine-tuned machine learning model, a logical form corresponding to the utterance based at least in part on the prompt;
executing the logical form on a database to obtain a query result; and
providing the query result to the user.

11. A system comprising:
one or more processors; and
one or more computer-readable media storing instructions which, when executed by the one or more processors, cause the system to perform operations comprising:
accessing domain data comprising a set of domain identifiers;
generating a set of synthetic training examples, wherein generating the set of synthetic training examples comprises performing an iterative process, and wherein the iterative process comprises:
generating, by one or more generative models, (i) a synthetic database schema based on the domain data, wherein the synthetic database schema comprises one or more tables, (ii) synthetic database content associated with the synthetic database schema, and (iii) a synthetic natural language utterance and a synthetic logical form based on the synthetic database schema and the synthetic database content, and
generating a synthetic training example of the set of synthetic training examples to include the synthetic database schema, the synthetic natural language utterance, and the synthetic logical form; and
fine-tuning a machine learning model with the set of synthetic training examples to generate a fine-tuned machine learning model.

12. The system of claim 11, wherein the operations further comprise:
accessing a rehearsal dataset comprising rehearsal training examples; and
generating a fine-tuning dataset comprising the set of synthetic fine-tuning training examples and a subset of the rehearsal training examples,
wherein the machine learning model is fine-tuned using the fine-tuning dataset.

13. The system of claim 12, wherein each rehearsal training example of the rehearsal training examples includes a training prompt and a gold logical form, and wherein the subset of the rehearsal training examples is determined by, for each rehearsal training example:
generating, by the one or more generative models, a synthetic rehearsal logical form based on the training prompt;
executing the synthetic rehearsal logical form and the gold logical form on a database, wherein executing the synthetic rehearsal logical form generates a synthetic rehearsal query result and wherein executing the gold logical form generates a rehearsal query result;
determining whether the synthetic rehearsal query result corresponds with the rehearsal query result; and
in accordance with determining that the synthetic rehearsal query result corresponds with the rehearsal query result, adding the rehearsal training example to the subset of the rehearsal training examples.

14. The system of claim 11, wherein generating the synthetic database schema comprises:
selecting a domain identifier from the set of domain identifiers;
identifying one or more keywords associated with the domain identifier, wherein the domain data includes the one or more keywords;
generating a business process description based on the domain identifier and the one or more keywords;
generating a database schema generation prompt comprising the domain identifier, the one or more keywords, and the business process description; and
providing the database schema generation prompt to the one or more generative models.

15. The system of claim 11, wherein generating the synthetic database content comprises:
identifying one or more table relationships based on the synthetic database schema;
determining an order of the one or more tables based on the one or more table relationships; and
generating table content for each table of the one or more tables based on the order, the one or more table relationships, and the synthetic database schema, wherein the table content is (i) random, (ii) extracted from a prior table, or (iii) any combination thereof.

16. The system of claim 11, wherein generating the synthetic natural language utterance and the synthetic logical form comprises:
generating, by the one or more generative models, the synthetic logical form based on the synthetic database schema comprising the one or more tables or only a subset of the one or more tables, and a gold logical form pattern;
generating, by the one or more generative models, the synthetic natural language utterance based on the synthetic logical form;
generating, by the one or more generative models, a back-translated logical form based on the synthetic natural language utterance;
executing the synthetic logical form and the back-translated logical form on a test database including the synthetic database content, wherein executing the synthetic logical form generates a synthetic query result and wherein executing the back-translated logical form generates a back-translated query result;
determining whether the synthetic query result corresponds with the back-translated query result; and
in accordance with determining that the synthetic query result does not correspond with the back-translated query result, discarding the synthetic logical form and the synthetic natural language utterance.

17. The system of claim 11, further comprising:
generating, by the one or more generative models, a schema description based on: (i) a domain description, (ii) a domain keyword, (iii) the synthetic database schema, (iv) a set of target columns, or (v) any combination thereof, and
generating, by the one or more generative models, a business logic rule based on the synthetic database schema,
wherein the schema description and the business logic rule are included in one or more prompts, and wherein the one or more prompts are provided to the one or more generative models to generate the synthetic natural language utterance and the synthetic logical form.

18. One or more non-transitory computer-readable media storing instructions which, when executed by one or more processors, cause the one or more processors to perform operations comprising:
accessing domain data comprising a set of domain identifiers;
generating a set of synthetic training examples, wherein generating the set of synthetic training examples comprises performing an iterative process, and wherein the iterative process comprises:
generating, by a first generative model, a synthetic database schema based on the domain data, wherein the synthetic database schema comprises one or more tables,
generating, by a second generative model, synthetic database content associated with the synthetic database schema,
generating, by a third generative model, a synthetic natural language utterance and a synthetic logical form based on the synthetic database schema and the synthetic database content, and
generating a synthetic training example of the set of synthetic training examples to include the synthetic database schema, the synthetic natural language utterance, and the synthetic logical form; and
fine-tuning a machine learning model with the set of synthetic training examples to generate a fine-tuned machine learning model.

19. The one or more non-transitory computer-readable media of claim 18, wherein the operations further comprise:
accessing a rehearsal dataset comprising rehearsal training examples; and
generating a fine-tuning dataset comprising the set of synthetic fine-tuning training examples and a subset of the rehearsal training examples,
wherein the machine learning model is fine-tuned using the fine-tuning dataset.

20. The one or more non-transitory computer-readable media of claim 18, wherein generating the synthetic database schema comprises:
selecting a domain identifier from the set of domain identifiers;
identifying one or more keywords associated with the domain identifier, wherein the domain data includes the one or more keywords;
generating a business process description based on the domain identifier and the one or more keywords;
generating a database schema generation prompt comprising the domain identifier, the one or more keywords, and the business process description; and
providing the database schema generation prompt to the first generative model.
